(19) United States
(12) Patent Application Publication
(10) Pub. No.: US 2009/0310880 A1
(43) Pub. Date: Dec. 17, 2009

(54) SIGNAL PROCESSING APPARATUS AND METHOD, AND PROGRAM

(76) Inventors: Kazuki YOKOYAMA, Kanagawa (JP); Tetsuji INADA, Kanagawa (JP); Yosuke YAMAMOTO, Chiba (JP); Mitsuyasu ASANO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/483,615

(22) Filed: Jun. 12, 2009

(30) Foreign Application Priority Data
Jun. 13, 2008 (JP) P2008-155209

(51) Int. Cl. G06K 9/40

(52) U.S. Cl. 382/260; 382/254; 382/274

(57) ABSTRACT

A signal processing apparatus includes a separation unit configured to separate first image data into a first component in which an edge of the first image data is saved and a second component in which elements other than the edge are saved, an improvement unit configured to apply a processing of improving a transient on the first component separated by the separation unit, and an adder unit configured to add the first component on which the processing by the improvement unit is applied with the second component separated by the separation unit and output second image data obtained as a result of the addition.

### BACKGROUND OF THE INVENTION

1. Field of the Invention

The present invention relates to a signal processing apparatus and method, and a program, in particular, a signal processing apparatus and method, and a program with which stable transient improvement can be carried out on an edge having a noise component and an edge having a small amplitude.

2. Description of the Related Art

Up to now, as a method of improving a transient of an image signal, a method of improving a transient by inputting a luminance signal itself is proposed. For example, a method described in Japanese Unexamined Patent Application Publication No. 7-59054 and a method disclosed by the present applicant in Japanese Unexamined Patent Application Publication No. 2006-081150 are relevant. It should be noted that with the method disclosed in Japanese Unexamined Patent Application Publication No. 2006-081150, a problem of Japanese Unexamined Patent Application Publication No. 7-59054 can be solved.

However, according to the above-mentioned method in the related art, the transient is improved for the luminance signal itself, and therefore depending on an influence of a noise component or the like, it may be difficult to carry out the stable improvement with respect to the temporal axis or the spatial axis in some cases. In such a case, wobble or break of the edge is caused. For this reason, there is a problem that it is difficult to carry out the improvement on an edge having a small amplitude.

The present invention has been made in view of the above-mentioned circumstances, and it is desirable to carry out a stable transient improvement on an edge having a noise component and an edge having a small amplitude.

### SUMMARY OF THE INVENTION

According to an embodiment of the present invention, there is provided a signal processing apparatus including: separation means configured to separate first image data into a first component in which an edge of the first image data is saved and a second component in which elements other than the edge are saved; improvement means configured to apply a processing of improving a transient on the first component separated by the separation means; and adder means configured to add the first component on which the processing by the improvement means is applied with the second component separated by the separation means and output second image data obtained as a result of the addition.

The separation means further includes filter means configured to apply a nonlinear filter in which the edge is saved on the first image data to extract and output the first component, and subtractor means configured to subtract the first component output from the filter means, from the first image data and output the second component obtained as a result of the subtraction.

The signal processing apparatus according to the embodiment of the present invention further includes correction means configured to correct a contrast on the first component on which the processing by the improvement means is applied, extraction means configured to apply a processing of extracting a contour from the first component on which the processing by the improvement means is applied to output a third component, first amplification means configured to apply an amplification processing on the third component output by the extraction means, and second amplification means configured to apply an amplification processing on the second component separated by the separation means, in which the first component on which the processing by the improvement means is applied and then on which the processing by the correction means is applied and the second component which is separated by the separation means and then on which the amplification processing by the second amplification means is applied are added with the third component on which the amplification processing by the first amplification means, and image data obtained as a result of the addition is output as second image data.

According to another embodiment of the present invention, there is provided a signal processing method for a signal processing apparatus, the method including the steps of: separating first image data into a first component in which an edge of the first image data is saved and a second component in which elements other than the edge are saved; applying a processing of improving a transient on the first component separated from the first image data; and adding the first component on which the processing is applied with the second component separated from the first image data and outputting second image data obtained as a result of the adding.

According to another embodiment of the present invention, there is provided a program for causing a computer to execute a processing including the steps of: separating first image data into a first component in which an edge of the first image data is saved and a second component in which elements other than the edge are saved; applying a processing of improving a transient on the first component separated from the first image data; and adding the first component on which the processing is applied with the second component separated from the first image data and outputting second image data obtained as a result of the adding.

As described above, according to the embodiment of the present invention, it is possible to perform the stable transient improvement on the edge having the noise component and the edge having the small amplitude.

### BRIEF DESCRIPTION OF THE DRAWINGS

FIG. 1 is a block diagram showing a configuration of a signal processing apparatus according to an embodiment of the present invention;

FIG. 2 is a flow chart for describing a signal processing according to an embodiment of the present invention;

FIG. 3 is an explanatory diagram for describing a signal processing of FIG. 1;

FIG. 4 is a block diagram showing a configuration of a nonlinear filter unit of FIG. 1;

FIG. 5 is a block diagram showing a configuration of a horizontal direction smoothing processing unit of FIG. 4;

FIG. 6 is a block diagram showing a configuration of a vertical direction smoothing processing unit of FIG. 4;

FIG. 7 is a block diagram showing a configuration of a nonlinear smoothing processing unit of FIG. 5;

FIG. 8 is a block diagram showing a configuration of a threshold setting unit of FIG. 5;

FIG. 9 is a flow chart for describing a nonlinear filter processing by the signal processing apparatus of FIG. 1 ;

FIG. 10 is a flow chart for describing a horizontal direction smoothing processing by the nonlinear filter unit of FIG. 4;

FIG. 11 is an explanatory diagram for describing the horizontal direction smoothing processing by the nonlinear filter unit of FIG. 4;

FIG. 12 is a flow chart for describing a threshold setting processing by the threshold setting unit of FIG. 8;

FIG. 13 is a flow chart for describing a nonlinear smoothing processing by the nonlinear filter unit of FIG. 4;

FIG. 14 is a flow chart for describing a minute edge determination processing by the nonlinear filter unit of FIG. 4;

FIG. 15 is an explanatory diagram for describing the minute edge determination processing by the nonlinear filter unit of FIG. 4;

FIG. 16 is an explanatory diagram for describing the minute edge determination processing by the nonlinear filter unit of FIG. 4;

FIG. 17 is an explanatory diagram for describing the minute edge determination processing by the nonlinear filter unit of FIG. 4;

FIG. 18 is an explanatory diagram for describing another method of setting a weighting by the nonlinear filter unit of FIG. 4;

FIG. 19 is an explanatory diagram for describing an effect of smoothing by way of a threshold which is set in a threshold setting of FIG. 8;

FIG. 20 is an explanatory diagram for describing the effect of smoothing by way of the threshold which is set in the threshold setting of FIG. 8;

FIG. 21 is an explanatory diagram for describing a vertical direction smoothing processing by the nonlinear filter unit of FIG. 4;

FIG. 22 is a block diagram showing a configuration of a transient improvement unit of FIG. 1;

FIG. 23 is an explanatory diagram for describing a transient improvement processing of FIG. 22;

FIG. 24 is a block diagram showing a configuration of a contour emphasis image processing apparatus according to an embodiment of the present invention;

FIG. 25 is a flow chart for describing a contour emphasis image processing;

FIG. 26 is an explanatory diagram for describing a problem of a transient improvement processing in a related art;

FIG. 27 is an explanatory diagram for describing a problem of the transient improvement processing in a related art;

FIG. 28 shows an effect of the transient improvement processing by the signal processing apparatus according to the embodiment of the present invention; and

FIG. 29 is a block diagram showing a configuration example of a computer included in a liquid crystal panel or configured to control a drive of the liquid crystal panel according to an embodiment of the present invention.

### DESCRIPTION OF THE PREFERRED EMBODIMENTS

Hereinafter, with reference to the drawings, a signal processing apparatus according to an embodiment of the present invention will be described.

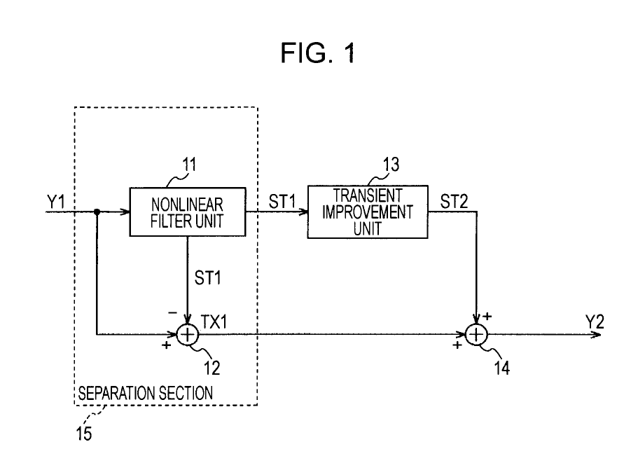

FIG. 1 shows a configuration example of the signal processing apparatus according to the embodiment of the present invention.

The signal processing apparatus according to the example of FIG. 1 can separate a luminance signal into a component in which an edge part is saved (hereinafter referred to as edge component) and a component other than the edge part, improve a transient of the edge component, and also amplify the component other than the edge component.

The signal processing apparatus according to the example of FIG. 1 is composed by including a nonlinear filter unit 11, a subtractor unit 12, a transient improvement unit 13, and the adder unit 14.

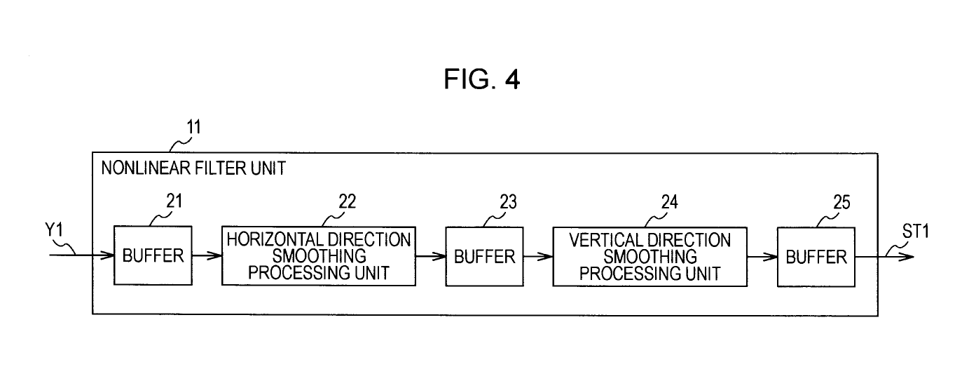

The nonlinear filter unit 11 extracts the edge component ST1 from the luminance signal Y1 of the input image data and supplies the edge component ST1 to the subtractor unit 12 and the transient improvement unit 13. It should be noted that a detailed example of the nonlinear filter unit 11 will be described below with reference to FIGS. 4 to 21.

The subtractor unit 12 subtracts the edge component ST1 from the luminance signal Y1 of the input image data and supplies the resultant component TX1 other than the edge to the adder unit 14.

Herein, the nonlinear filter unit 11 and the subtractor unit 12 are collectively examined, it can be understood that luminance data Y1 of the input image is separated into the edge component ST1 and the component TX1 other than the edge, the edge component ST1 is supplied to the transient improvement unit 13, and the component TX1 other than the edge is supplied to the adder unit 14. In view of the above, the nonlinear filter unit 11 and the subtractor unit 12 will be hereinafter collectively referred to as separation section 15.

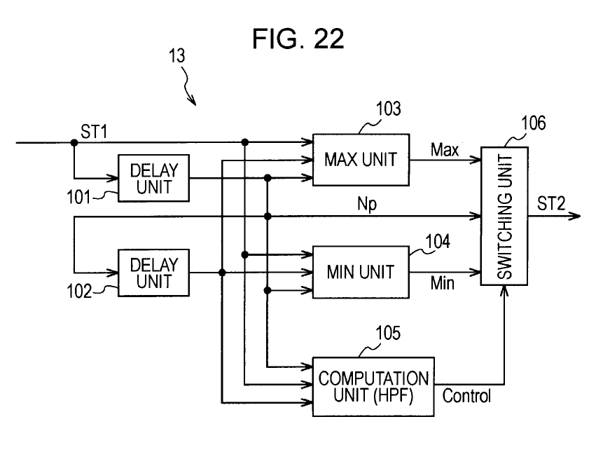

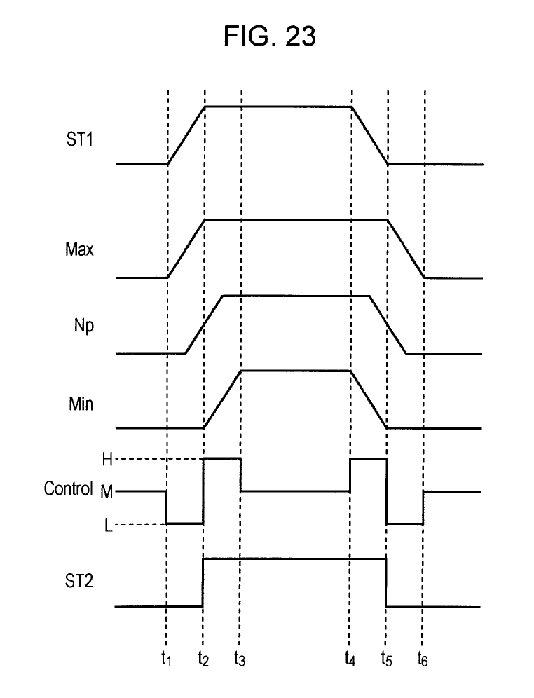

The transient improvement unit 13 applies a predetermined transient improvement processing on the edge component ST1 supplied from the nonlinear filter unit 11 and supplies an edge component ST2 obtained as a result of the processing, that is, the edge component ST2 in which the transient of the edge is improved to the adder unit 14. It should be noted that hereinafter, the edge component ST2 in which the transient of the edge is improved will be referred to as improved edge component ST2. A detailed example of the transient improvement unit 13 will be described with reference to FIGS. 22 and 23.

The adder unit 14 adds the improved edge component ST2 supplied from the transient improvement unit 13 with the component TX1 other than the edge supplied from the subtractor unit 12 and outputs a luminance signal Y2 obtained as a result of the addition, that is, the luminance signal Y2 in which the transient of the edge only is improved.

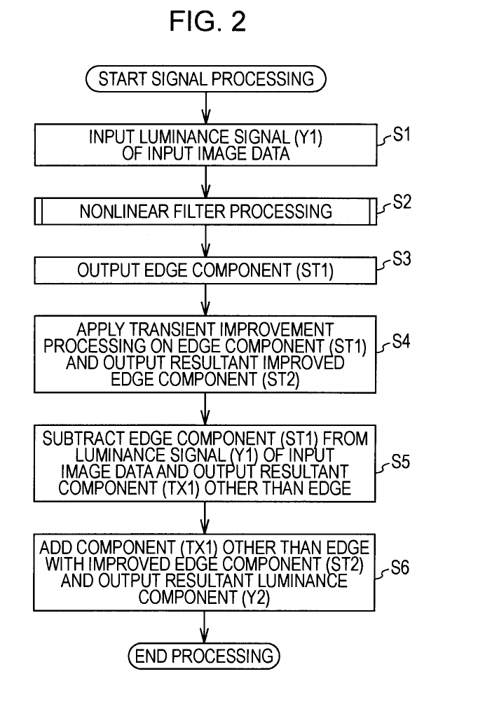

Next, with reference to a flow chart of FIG. 2, an image processing by the signal processing apparatus of FIG. 1 will be described.

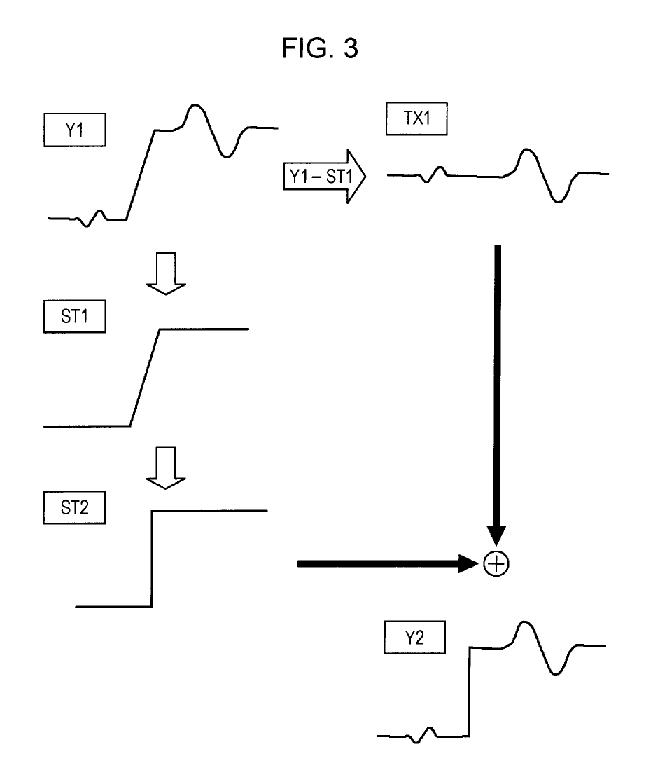

In step S1, the signal processing apparatus inputs the luminance signal Y1 of the input image data. The input luminance signal Y1 is supplied to the nonlinear filter unit 11 and the subtractor unit 12. For example, FIG. 3 shows waveform examples of the luminance signal Y1 of the input image data. It should be noted that the respective waveforms shown in FIG. 3 are waveforms connecting luminance levels of the respective pixels in a predetermined range of a predetermined one line.

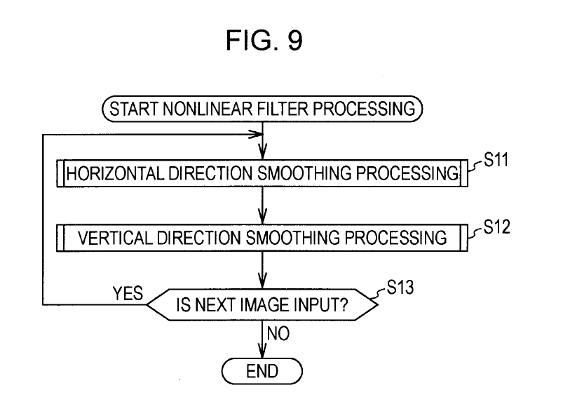

In step S2, the nonlinear filter unit 11 applies a nonlinear filter processing on the luminance signal Y1 of the input image data. As a result, the edge component ST1 is obtained. It should be noted that a detailed example of the nonlinear filter processing will be described below by using FIGS. 9 to 21. For example, when the nonlinear filter processing in step S2 is applied on the luminance signal Y1 having the waveform shown in FIG. 3, the edge component ST1 having a waveform shown in a lower part thereof is obtained. That is, FIG. 3 shows a waveform example of the edge component ST1.

In step S3, the nonlinear filter unit 11 outputs the edge component ST1. The output edge component ST1 is supplied to the transient improvement unit 13 and the subtractor unit 12.

In step S4, the transient improvement unit 13 applies the transient improving processing on the edge component ST1 and outputs the improved edge component ST2 obtained as a result of the processing. The output improved edge component ST2 is supplied to the adder unit 14. It should be noted that a detail example of the transient improvement processing will be described below by using FIGS. 22 and 23. For example, when the transient improvement processing in step S4 is applied on the edge component ST1 having the waveform shown in FIG. 3, the improved edge component ST2 having a waveform shown in a lower part thereof is obtained. That is, FIG. 3 shows a waveform example of the improved edge component ST2.

In step S5, the subtractor unit 12 subtracts the edge component ST1 from the luminance signal Y1 of the input image data and outputs the resultant component TX1 other than the edge. The output component TX1 other than the edge is supplied to the adder unit 14. For example, when the edge component ST1 having the waveform in the lower part is subtracted from the luminance component Y1 of the waveform shown in FIG. 3, the component TX1 other than the edge having a waveform shown in an upper right part of FIG. 3 is obtained. That is, FIG. 3 shows a waveform example of the component TX1 other than the edge.

In step S6, the adder unit 14 adds the component TX1 other than the edge from the subtractor unit 12 with the improved edge component ST2 from the transient improvement unit 13 and outputs a luminance component Y2 obtained as a result of the addition. For example, when the component TX1 other than the edge having the waveform in the upper right part of FIG. 3 is added with the improved edge component ST2 having a waveform in a lower left part of FIG. 3, the luminance component Y2 having a waveform in lower right part of FIG. 3 is obtained. That is, FIG. 3 shows a waveform example of the luminance component Y2. As is understood from this waveform of FIG. 3, the transient of the edge only in the luminance component Y2 is improved as compared with the luminance signal Y1 of the input image data.

Next, with reference to FIG. 4, a detailed configuration of the nonlinear filter unit 11 will be described.

A buffer 21 temporarily stores an input image signal and supplies the image signal to a horizontal direction smoothing processing unit 22 in a later stage. The horizontal direction smoothing processing unit 22 uses neighboring pixels arranged in the horizontal direction with respect to a target pixel and the target pixel to apply the nonlinear smoothing processing on the target pixel in the horizontal direction to be supplied to a buffer 23. The buffer 23 temporarily stores image signals supplied from the horizontal direction smoothing processing unit 22 and sequentially supplies the image signals to a vertical direction smoothing processing unit 24. The vertical direction smoothing processing unit 24 uses neighboring pixels arranged in the vertical direction with respect to a target pixel and the target pixel to apply the nonlinear smoothing processing on the target pixel to be supplied to a buffer 25. The buffer 25 temporarily stores image signals composed of pixels subjected to the nonlinear smoothing in the vertical direction which are supplied from the vertical direction smoothing processing unit 24 and outputs the image signals to an apparatus not shown in a later stage.

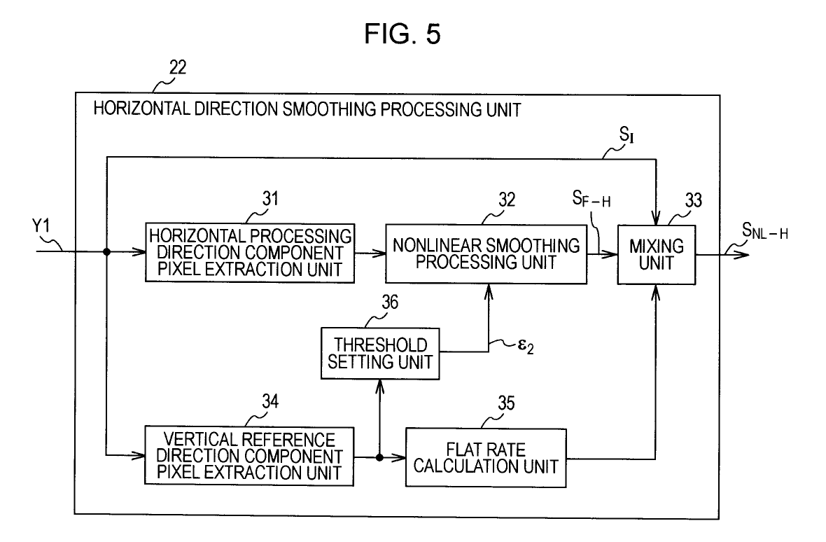

Next, with reference to FIG. 5, a detailed configuration of the horizontal direction smoothing processing unit 22 will be described.

A horizontal processing direction component pixel extraction unit 31 sequentially sets the target pixel from the respective pixels of the image signals stored in the buffer 21 and also extracts a pixel used for the nonlinear smoothing processing corresponding to the target pixel to be output to a nonlinear smoothing processing unit 32. To be more specific, the horizontal processing direction component pixel extraction unit 31 extracts two adjacent pixels each in the left and right with respect to the target pixel in the horizontal direction as horizontal processing direction component pixels and supplies the respective pixel values of the extracted four pixels and the target pixel to the nonlinear smoothing processing unit 32. It should be noted that the number of pixels of the horizontal processing direction component pixels to be extracted is not limited to two adjacent pixels each in the left and right with respect to the target pixel, but any pixels may be used which are adjacent in the horizontal direction. For example, three adjacent pixels each in the left and right with respect to the target pixel may be used, or furthermore, one adjacent pixel with respect to the target pixel in the left direction and three adjacent pixels with respect to the target pixel in the right direction may also be used.

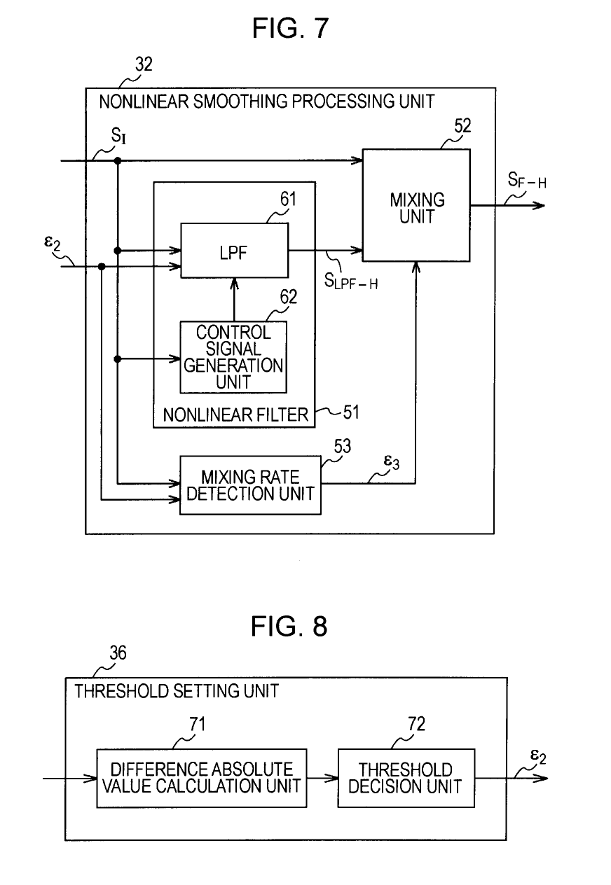

The nonlinear smoothing processing unit 32 uses the target pixel and the horizontal processing direction component pixels which are the two adjacent pixels each in the left and right with respect to the target pixel supplied from the horizontal processing direction component pixel extraction unit 31 and applies the nonlinear smoothing processing on the target pixel on the basis of a threshold ε₂ supplied from a threshold setting unit 36 to be supplied to a mixing unit 33. It should be noted that a configuration of the nonlinear smoothing processing unit 32 will be described below with reference to FIG. 7. Also, herein, the nonlinear smoothing processing applied in the horizontal direction is a processing of setting the target pixel subjected to the nonlinear smoothing by using a plurality of pixels adjacent to the target pixel in the horizontal direction. Similarly, the nonlinear smoothing processing applied in the vertical direction to be described below is a processing of setting the target pixel subjected to the nonlinear smoothing by using a plurality of pixels adjacent to the target pixel in the vertical direction.

A vertical reference direction component pixel extraction unit 34 sequentially sets the target pixel from the respective pixels of the image signals stored in the buffer 21, and also extracts pixels adjacent in the vertical direction corresponding to the target pixel which is different from the direction, in which the pixels used for the nonlinear smoothing processing are arranged, to be output to a Flat rate calculation unit 35 and the threshold setting unit 36. To be more specific, the vertical reference direction component pixel extraction unit 34 extracts two adjacent pixels each in the upper and lower sides with respect to the target pixel in the vertical direction as vertical reference direction component pixels and supplies the respective pixel values of the extracted four pixels and the target pixel the Flat rate calculation unit 35 and the threshold setting unit 36. It should be noted that the number of pixels of the vertical reference direction component pixels to be extracted is not limited to two adjacent pixels each in the upper and lower sides with respect to the target pixel, but any pixels may be used which are adjacent in the vertical direction. For example, three adjacent pixels each in the upper and lower sides with respect to the target pixel may be used. Furthermore, one adjacent pixel with respect to the target pixel in the up direction and three adjacent pixels with respect to the target pixel in the down direction may also be used.

The Flat rate calculation unit 35 obtains difference absolute values of the respective pixel values of the target pixel and the vertical reference direction component pixels supplied from the vertical reference direction component pixel extraction unit 34 and sets a maximum value of the difference absolute values as a Flat rate to be supplied to the mixing unit 33. Herein, the Flat rate in the vertical direction represents a change in the difference absolute values of the target pixel and the vertical reference direction component pixels. When the Flat rate is large, it represents that the image is a non-flat image in which the change in the pixel values of the pixels near the target pixel is large, and the correlation between the pixels in the vertical direction is small (a non-flat image with a large change in the pixel values). In contrast, when the Flat rate is small, it represents that the image is a flat image in which the change in the pixel values of the pixels near the target pixel is small, the correlation between the pixels in the vertical direction is large (a Flat image with a small change in the pixel values).

On the basis of a Flat rate in the vertical direction supplied from the Flat rate calculation unit 35, the mixing unit 33 mixes the pixel values of the target pixel subjected to a nonlinear smoothing processing and the unprocessed target pixel to be output as a pixel subjected to a horizontal direction smoothing processing to the buffer 23 in a later stage.

The threshold setting unit 36 uses pixels adjacent in the vertical direction which is different from the direction, in which the pixels used for the nonlinear smoothing processing are arranged, corresponding to the target pixel to set a threshold ε₂ used for the nonlinear smoothing processing in the nonlinear smoothing processing unit 32 to be supplied to the nonlinear smoothing processing unit 32. It should be noted that a configuration of the threshold setting unit 36 will be described in detail with reference to FIG. 8.

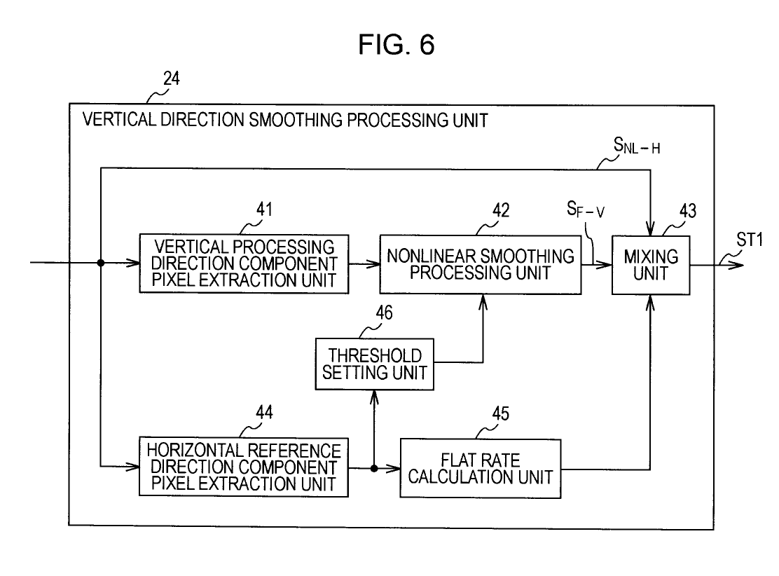

Next, with reference to FIG. 6, a detailed configuration of the vertical direction smoothing processing unit 24 will be described.

The vertical direction smoothing processing unit 24 basically has a configuration of the horizontal direction smoothing processing unit 22 in which the processing in the horizontal direction is replaced by the processing in the vertical direction. That is, a vertical processing direction component pixel extraction unit 41 sequentially sets the target pixel from the respective pixels stored in the buffer 23, and also extracts pixels used for the nonlinear smoothing processing corresponding to the target pixel to be output to a nonlinear smoothing processing unit 42. To be more specific, the vertical processing direction component pixel extraction unit 41 extracts two adjacent pixels each in the upper and lower sides with respect to the target pixel in the vertical direction as vertical processing direction component pixels and supplies the respective pixel values of the extracted four pixels and the target pixel to the nonlinear smoothing processing unit 42. It should be noted that the number of pixels of the vertical reference direction component pixels to be extracted is not limited to two adjacent pixels each in the upper and lower sides with respect to the target pixel, but any pixels may be used which are adjacent in the vertical direction. For example, three adjacent pixels each in the upper and lower sides with respect to the target pixel may be used. Furthermore, one adjacent pixel with respect to the target pixel in the up direction and three adjacent pixels with respect to the target pixel in the down direction may also be used.

The nonlinear smoothing processing unit 42 uses the target pixel and the vertical processing direction component pixels which are the two adjacent pixels each in the upper and lower sides with respect to the target pixel supplied from the vertical processing direction component pixel extraction unit 41, and applies the nonlinear smoothing processing on the target pixel in the vertical direction on the basis of the threshold ε₂ supplied from a threshold setting unit 46 to be supplied to a mixing unit 43. The configuration of the nonlinear smoothing processing unit 42 is similar to that of the nonlinear smoothing processing unit 32, and a detail thereof will be described below with reference to FIG. 7.

A horizontal reference direction component pixel extraction unit 44 sequentially sets the target pixel from the respective pixels stored in the buffer 23, and also extracts pixels adjacent in the horizontal direction which is different from the direction in which the pixels used for the nonlinear smoothing processing corresponding to the target pixel are arranged to be output to a Flat rate calculation unit 45 and the threshold setting unit 46. To be more specific, the horizontal reference direction component pixel extraction unit 44 extracts two pixels each adjacent in the left and right in the horizontal direction with reference to the target pixel and supplies the respective pixel values of the extracted four pixels and the target pixel to be supplied to the Flat rate calculation unit 45 and the threshold setting unit 46. It should be noted that the number of pixels of the horizontal processing direction component pixels to be extracted is not limited to two adjacent pixels each in the left and right with respect to the target pixel, but any pixels may be used which are adjacent in the horizontal direction. For example, three adjacent pixels each in the horizontal direction with respect to the target pixel may be used, or furthermore, one adjacent pixel with respect to the target pixel in the left direction and three adjacent pixels with respect to the target pixel in the right direction may also be used.

The Flat rate calculation unit 45 obtains difference absolute values of the respective pixel values of the target pixel and the pixels adjacent in the left and right with respect to the target pixel supplied from the horizontal reference direction component pixel extraction unit 44 and supplies a maximum value of the difference absolute values as a Flat rate to the mixing unit 43.

On the basis of the Flat rate in the horizontal direction supplied from the Flat rate calculation unit 45, the mixing unit 43 mixes the pixel values of the target pixel subjected to the nonlinear smoothing processing and the unprocessed target pixel to be output to the buffer 25 in a later stage as the pixel subjected to the horizontal direction smoothing processing.

The threshold setting unit 46 uses the pixels adjacent in the horizontal direction which is different from the direction in which the pixels used for the nonlinear smoothing processing corresponding to the target pixel are arranged to set the threshold ε₂ used for the nonlinear smoothing processing in the nonlinear smoothing processing unit 32 to be supplied to the nonlinear smoothing processing unit 42. It should be noted that the configuration of the threshold setting unit 46 is similar to that of the threshold setting unit 36, and a detail thereof will be described below with reference to FIG. 8.

Next, with reference to FIG. 7, a detail configuration of the nonlinear smoothing processing unit 32 will be described.

A nonlinear filter 51 of the nonlinear smoothing processing unit 32 holds a precipitous edge whose size is larger than the threshold ε₂ supplied from the threshold setting unit 36 among variations of the pixels constituting the luminance signal Y1 of the input image data, and also performs a smoothing processing on a part other than the edge to output an image signal subjected to the smoothing processing S_{LPF-H} to a mixing unit 52.

A mixing rate detection unit 53 obtains a threshold ε₃ which is sufficiently smaller than the threshold ε₂ supplied from the threshold setting unit 36 and detects a minute change in the variations of the pixels constituting the luminance signal Y1 of the input image data on the basis of the threshold ε₃. The mixing rate detection unit 53 uses the detection result to calculate a mixing rate to be supplied to the mixing unit 52.

The mixing unit 52 mixes the image signal subjected to the smoothing processing S_{LPF-H} and the luminance signal Y1 of the input image data which is not subjected to the smoothing processing on the basis of the mixing rate supplied from the mixing rate detection unit 53 to be output as an image signal subjected to the nonlinear smoothing processing S_{F-H}.

On the basis of the control signal supplied from a control signal generation unit 62 and the threshold ε₂ supplied from the threshold setting unit 36, an LPF (Low Pass Filter) 61 of the nonlinear filter 51 uses the pixel values of the target pixel and the horizontal processing direction component pixels which are two adjacent pixels each in the left and right in the horizontal direction to apply the smoothing processing on the target pixel and output the image signal subjected to the smoothing processing S_{LPF-H} to the mixing unit 52. The control signal generation unit 62 calculates the difference absolute values of the pixel values between the target pixel and the horizontal processing direction component pixels and generates control signals for controlling the LPF 61 on the basis of the calculation results to be supplied to the LPF 61. It should be noted that for the nonlinear filter 51, for example, the above-mentioned ε filter in the related art may also be used.

Next, with reference to FIG. 8, a configuration of the threshold setting unit 36 will be described.

A difference absolute value calculation unit 71 obtains difference absolute values between the target pixel and the respective pixels adjacent in the vertical direction which is different from the direction, in which the pixels used for the nonlinear smoothing processing are arranged, corresponding to the target pixel to be supplied to a threshold decision unit 72. The threshold decision unit 72 decides a value obtained by adding a predetermined margin to the maximum value of the difference absolute values supplied from the difference absolute value calculation unit 71 as the threshold ε₂ to be supplied to the nonlinear smoothing processing unit 32. It should be noted that the threshold setting unit 46 has a configuration similar to that of the threshold setting unit 36, and the representation in the drawing is omitted. In the threshold setting unit 46, the difference absolute value calculation unit 71 obtains difference absolute values between the target pixel and the respective pixels adjacent in the horizontal direction which is different from the direction, in which the pixels used for the nonlinear smoothing processing are arranged, to be supplied to the threshold decision unit 72.

Next, with reference to a flow chart of FIG. 9, the nonlinear filter processing by the nonlinear filter unit 11 of FIG. 4 will be described.

In step S11, the horizontal direction smoothing processing unit 22 uses the image signals which are sequentially stored in the buffer 21 to execute the horizontal direction smoothing processing.

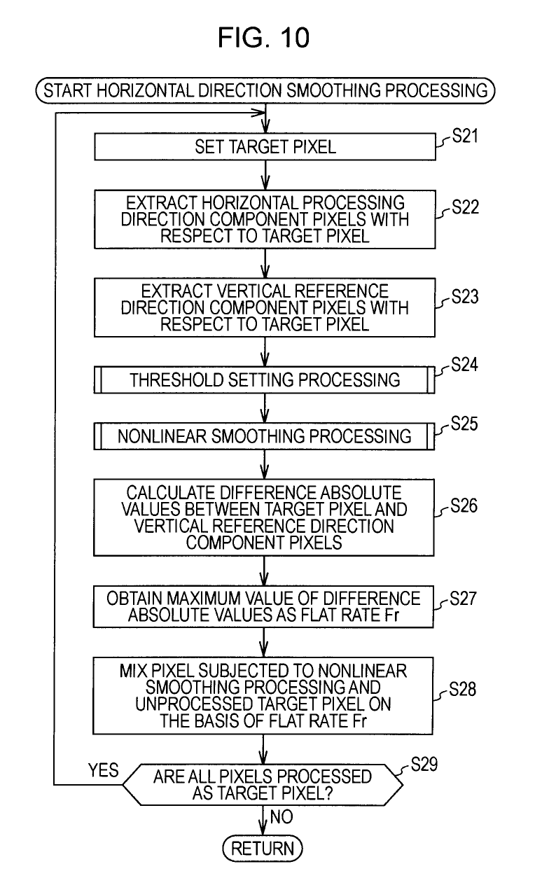

Herein, with reference to a flow chart of FIG. 10, the horizontal direction smoothing processing by the horizontal direction smoothing processing unit 22 will be described.

In step S21, the horizontal processing direction component pixel extraction unit 31 of the horizontal direction smoothing processing unit 22 sets the target pixel in the raster scan order. At the same time, the vertical reference direction component pixel extraction unit 34 also similarly sets the target pixel in the raster scan order. It should be noted that the setting order of the target pixel may be in an order other than the raster scan, but the target pixel set by the horizontal processing direction component pixel extraction unit 31 and the target pixel set by the vertical reference direction component pixel extraction unit 34 should be set identical to each other.

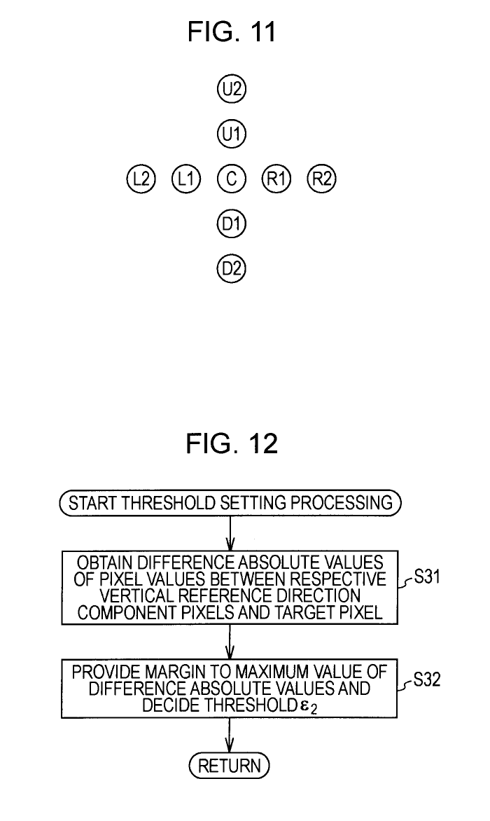

In step S22, the horizontal processing direction component pixel extraction unit 31 extracts pixel values of total five pixels including the target pixel and also the horizontal processing direction component pixels which are the neighboring two pixels each adjacent in the horizontal direction (left and right direction) with respect to the target pixel from the buffer 21 to be output to the nonlinear smoothing processing unit 32. For example, in the case shown in FIG. 11, pixels L2, L1, C, R1, and R2 are extracted as the target pixel and the horizontal processing direction component pixels. It should be noted that in FIG. 11, the pixel C is the target pixel, the pixels L2 and L1 are the two horizontal processing direction component pixels adjacent on the left side of the target pixel C, and the pixels R1 and R2 are the two horizontal processing direction component pixels adjacent on the right side of the target pixel C.

In step S23, the vertical reference direction component pixel extraction unit 34 extracts pixel values of total five pixels including the target pixel and also the target pixel and the vertical reference direction component pixels which are the neighboring two pixels each adjacent in the vertical direction (up and down direction) with respect to the target pixel from the buffer 21 to be output to the Flat rate calculation unit 35 and the threshold setting unit 36. For example, in the case shown in FIG. 11, pixels U2, U1, C, D1, and D2 are extracted as the target pixel the vertical reference direction component pixels. It should be noted that in FIG. 9, the pixel C is the target pixel, the pixels U2 and U1 are the two vertical reference direction component pixels adjacent on the upper side of the target pixel C, and the pixels D1 and D2 are the two vertical reference direction component pixels adjacent on the lower side of the target pixel C.

In step 24, the threshold setting unit 36 executes the threshold setting processing.

Herein, with reference to a flow chart of FIG. 12, the threshold setting processing will be described.

In step S31, the difference absolute value calculation unit 71 obtains difference absolute values of the pixel values between the target pixel and the vertical reference direction pixels to be supplied to the threshold decision unit 72. For example, in the case of FIG. 11, the target pixel is the pixel C, and the vertical reference direction pixels are the pixels U2, U1, D1, and D2. Thus, the difference absolute value calculation unit 71 calculates |C−U2|, |C−U1|, |C−D2|, and |C−U1| to be supplied to the threshold decision unit 72.

In step S32, the threshold decision unit 72 decides a difference absolute value with the maximum value of the difference absolute values supplied from the difference absolute value calculation unit 71 as the threshold ε₂ to be supplied to the nonlinear smoothing processing unit 32. Therefore, in the case of FIG. 11, the threshold decision unit 72 searches for the maximum value of |C−U2|, |C−U1|, |C−D2|, and |C−U1| and adds a predetermined margin to the maximum value to be set as the threshold ε₂. Herein, the addition of the margin means, for example, that (the maximum value of the difference absolute values)×1.1 is set as the threshold β₂ in a case where 10% margin is added.

Herein, the description is back to the flow chart of FIG. 10.

In step S24, when the threshold setting processing is ended, in step S25, the nonlinear smoothing processing unit 32 applies the nonlinear smoothing processing on the target pixel on the basis of the target pixel and the horizontal processing direction component pixels supplied from the horizontal processing direction component pixel extraction unit 31.

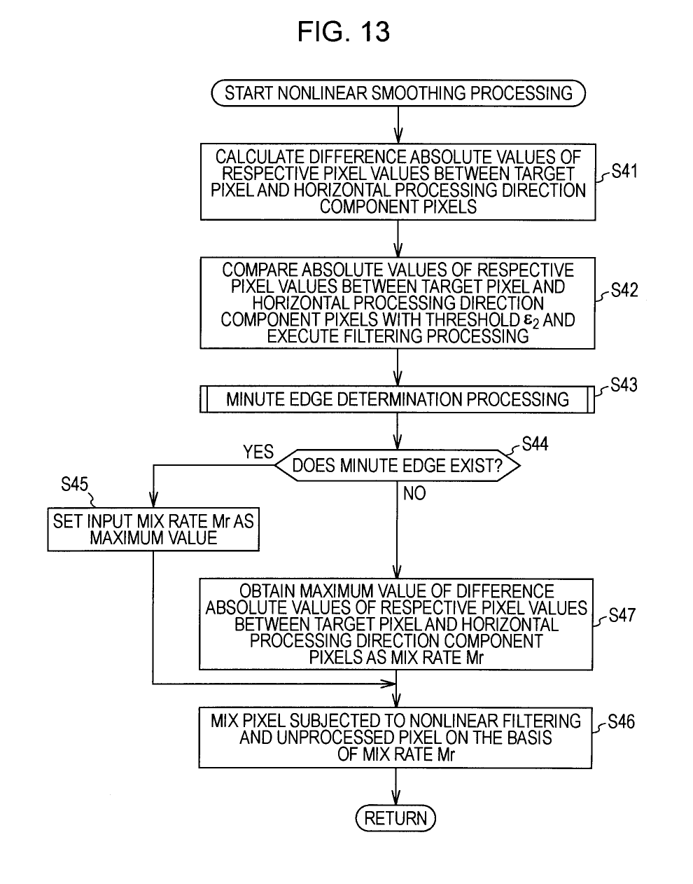

Herein, with reference to a flow chart of FIG. 13, the nonlinear smoothing processing by the nonlinear smoothing processing unit 32 will be described.

In step S41, the control signal generation unit 62 of the nonlinear filter 51 calculates difference absolute values of the pixel values between the target pixel and the horizontal processing direction component pixels. That is, in the case of FIG. 11, the control signal generation unit 62 calculates difference absolute values |C−L2|, |C−L1|, |C−R1|, and |C−R2| of the pixel values between the target pixel C and the horizontal processing direction component pixels L2, L1, R1, and R2 which are the respective neighboring pixels adjacent in the horizontal direction.

In step S42, the low-pass filter 61 compares with the respective difference absolute values calculated by the control signal generation unit 62 with the threshold ε₂ set by the threshold setting unit 36 and applies the nonlinear filtering processing on the luminance signal Y1 of the input image data in accordance with this comparison result. To be more specific, for example, as in Expression (1), the low-pass filter 61 uses a tap coefficient to obtain a weighted average of the pixel values of the target pixel C and the horizontal processing direction component pixels, and output a conversion result C′ corresponding to the target pixel C as the image signal subjected to the smoothing processing S_{LPF-H} to the mixing unit 52. It should be noted that as to the horizontal processing direction component pixel whose difference absolute value with the pixel value of the target pixel C is larger than the predetermined threshold ε₂, the pixel value is replaced by the pixel value of the target pixel C to obtain the weighted average (for example, the computation is carried out as in Expression (2)).

In step S43, the mixing rate detection unit 53 executes a minute edge determination processing to determine whether or not a minute edge exists.

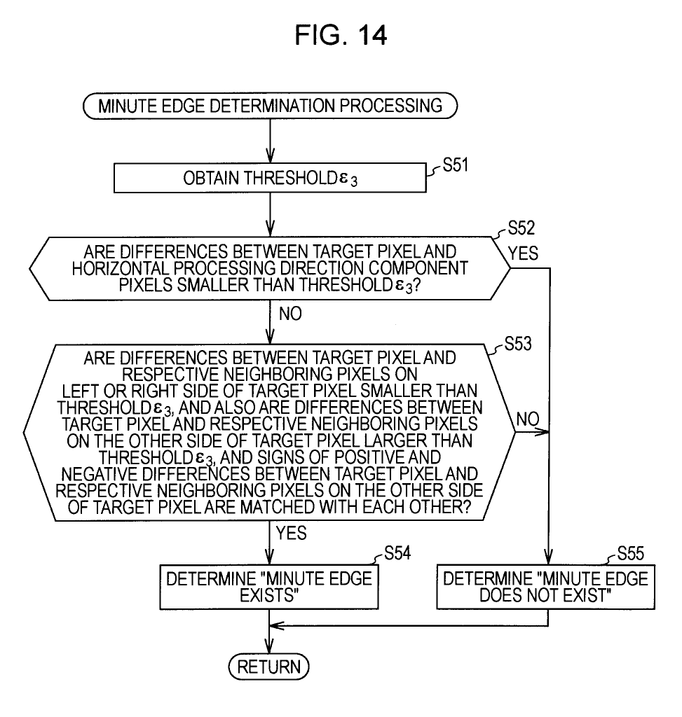

Herein, with reference to a flow chart of FIG. 14, the minute edge determination processing will be described.

In step S51, on the basis of the threshold ε₂ respectively supplied from the threshold setting unit 36, the mixing rate detection unit 53 obtains the threshold ε₃ used for detecting the presence or absence of the minute edge. To be more specific, the threshold ε₃ has a condition of being sufficiently smaller than the threshold ε₂ (ε₃<<ε₂). Thus, for example, a value obtained by multiplying the threshold ε₂ by a sufficiently small coefficient as the threshold ε₃.

In step S52, the mixing rate detection unit 53 calculates the difference absolute values of the pixel values between the target pixel and the respective horizontal processing direction component pixels to determine whether or not all the respective difference absolute values are smaller than the threshold ε₃ (<<ε₂), and on the basis of the determination result, it is determined whether or not the minute edge exists.

That is, for example, as shown in FIG. 11, the mixing rate detection unit 53 calculates the difference absolute values of the pixel values between the target pixel C and the respective horizontal processing direction component pixels L2, L1, R1, and R2 adjacent in the horizontal direction to determine whether or not all the respective difference absolute values are smaller than the threshold ε₃. In a case where it is determined that all the respective difference absolute values are smaller than the threshold ε₃, it is regarded that the pixel values of the neighboring pixels and the target pixel are not changed. The process advances to step S54, and it is determined that no minute edge exists in the vicinity of the target pixel.

On the other hand, in step S52, in a case where it is determined that at least one of the calculated difference absolute values is equal to or larger than the threshold ε₃, the process advances to step S53, and the mixing rate detection unit 53 determines whether or not all the difference absolute values between the horizontal processing direction component pixels on one of the lift and right sides of the target pixel and the target pixel are smaller than the threshold ε₃, whether or not all the difference absolute values between the target pixel on the other side of the horizontal processing direction component pixels and the target pixel are equal to or larger than the threshold ε₃, and also whether or not signs of positive and negative of the respective differences between the horizontal processing direction component pixels on the other side of the target pixel and the target pixel are matched with each other.

That is, in a case where the horizontal processing direction component pixels on one of the left and right sides of the target pixel C are, for example, the pixels L2 and L1 of FIG. 11, and the horizontal processing direction component pixels on the other side of the target pixel C are the pixels R2 and R1 of FIG. 11, the mixing rate detection unit 53 determines whether or not all the difference absolute values between the horizontal processing direction component pixels on one of the left and right sides of the target pixel C and the target pixel C are smaller than the threshold ε₃, whether or not all the difference absolute values between the horizontal processing direction component pixels R1 and R2 on the other side of the target pixel C and the target pixel C are equal to or larger than the threshold ε₃, and also whether or not the signs of positive and negative of the respective differences between the horizontal processing direction component pixels R1 and R2 on the other side of the target pixel C and the target pixel C are matched with each other.

For example, in a case where it is determined that the above-mentioned conditions are satisfied, in step S54, the mixing rate detection unit 53 determines that the minute edge exists in the vicinity of the target pixel.

On the other hand, in step S53, in a case where it is determined that the above-mentioned conditions are not satisfied, in step S55, the mixing rate detection unit 53 determines that the minute edge does not exist in the vicinity of the target pixel.

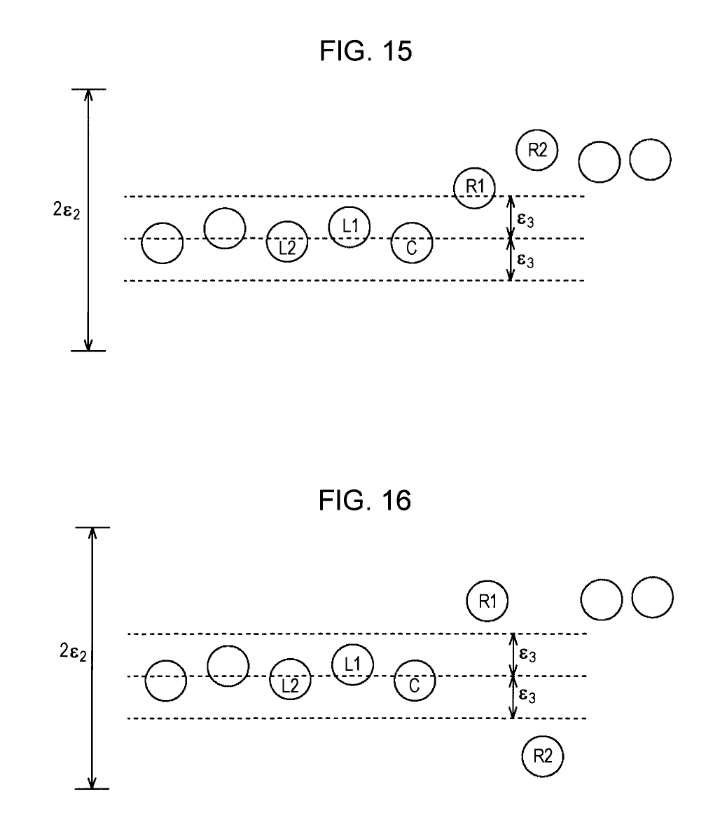

For example, in a case where the relation between the target pixel C and the horizontal processing direction component pixels L2, L1, R1, and R2 is represented by FIG. 15, the difference absolute values |L2−C| and |L1−C| between the target pixel C and the horizontal processing direction component pixels L2 and L1 on the left side are smaller than the threshold ε₃, the difference absolute values |R1−C| and |R2−C| between the target pixel C and the horizontal processing direction component pixels R1 and R2 on the right side are equal to or larger than the threshold ε₃, and also the signs of the differences (R1−C) and (R2−C) between the target pixel C and the horizontal processing direction component pixels R1 and R2 on the right side are matched with each other (both positive in the present case), and it is thus determined that the minute edge exists in the vicinity of the target pixel C.

Also, for example, in a case where the relation between the target pixel C and the horizontal processing direction component pixels L2, L1, R1, and R2 is represented by FIG. 16, the difference absolute values |L2−C| and |L1−C| between the target pixel C and the horizontal processing direction component pixels L2 and L1 on the left side are smaller than the threshold ε₃, the difference absolute values |R1−C| and |R2−C| between the target pixel C and the horizontal processing direction component pixels R1 and R2 on the right side are equal to or larger than the threshold ε₃, but the signs of the differences (R1−C) and (R2−C) between the target pixel C and the horizontal processing direction component pixels R1 and R2 on the right side are not matched with each other (positive and negative, respectively, in the present case), and it is thus determined that the minute edge does not exist in the vicinity of the target pixel C.

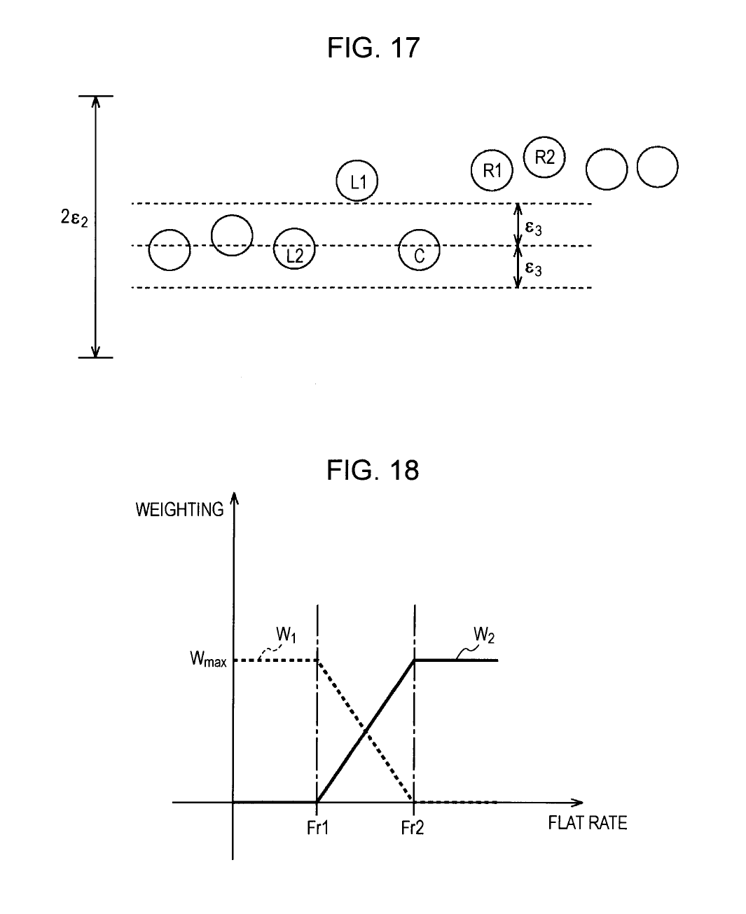

Furthermore, for example, in a case where the relation between the target pixel C and the horizontal processing direction component pixels L2, L1, R1, and R2 is represented by FIG. 17, on both the left and right sides of the target pixel C, not all the difference absolute values between the target pixel C and the horizontal processing direction component pixels are smaller than the threshold ε₃, and it is thus determined that the minute edge does not exist in the vicinity of the target pixel C.

In this manner, after it is determined whether the minute edge exists in the vicinity of the target pixel, the processing is returned to step S44 of FIG. 13.

When the processing in step S43 is ended, in step S44, the mixing rate detection unit 53 determines whether or not the determination result by the minute edge determination processing in step S43 is “the minute edge exists in the vicinity of the target pixel C”. For example, in a case where the determination result by the minute edge determination processing is “the minute edge exists in the vicinity of the target pixel C”, in step S45, the mixing rate detection unit 53 outputs the Mix rate Mr_{-H} which is the mixing rate of the image signal subjected to the nonlinear filtering processing in the horizontal direction S_{LPF-H} and the luminance signal Y1 of the input image data as the maximum Mix rate Mr_{-H max} to the mixing unit 52. It should be noted that the maximum Mix rate Mr_{-H max} is the maximum value of the Mix rates Mr_{-H}, that is, the difference absolute value between the maximum value and the minimum value in the dynamic range of the pixel values.

In step S46, on the basis of the Mix rate Mr_{-H} supplied from the mixing rate detection unit 53, the mixing unit 52 mixes the luminance signal Y1 of the input image data with the image signal S_{LPF-H} subjected to the nonlinear smoothing processing by the nonlinear filter 51 to be output as the image signal subjected to the nonlinear smoothing processing S_{F-H} to the buffer 23. In more detail, the mixing unit 52 computes the following Expression (3) and mixes the luminance signal Y1 of the input image data with the image signal subjected to the nonlinear smoothing processing S_{LPF-H} by the nonlinear filter.

S_{F-H}=Y1×M_{r-H}/Mr_{-H max}+S_{LPF-H}×(1−Mr_{-H}/Mr_{-H max}) (3)

Herein, Mr_{-H} denotes the Mix rate, and Mr_{-H max} denotes a maximum value of the Mix rates Mr_{-H}, that is, a difference absolute value between the maximum value and the minimum value of the pixel values.

As represented by Expression (3), when the Mix rate Mr_{-H} is large, the weighting of the image signal subjected to the nonlinear filtering processing S_{LPF-H} by the nonlinear filter 51 is small, and the weighting of the unprocessed luminance signal Y1 of the input image data becomes large. In contrast, when the Mix rate Mr_{-H} is small, that is, as the difference absolute value of the pixel values between the adjacent pixels in the horizontal direction is smaller, the weighting of the image signal subjected to the nonlinear filtering processing S_{LPF-H} is larger, and the weighting of the input unprocessed image signal becomes small.

Therefore, in a case where the minute edge is detected, the Mix rate Mr_{-H} is the maximum Mix rate Mr_{-H max}, and therefore the luminance signal Y1 of the input image data is output substantially as it is.

On the other hand, in step S44, in a case where it is determined “the minute edge does not exist”, in step S47, the mixing rate detection unit 53 respectively calculates the difference absolute values of the pixel values between the target pixel and the respective horizontal processing direction component pixels and obtains the maximum value of the calculated respective difference absolute values as the Mix rate Mr_{-H} which is the mixing rate to be output to the mixing unit 52. Then, the process advances to step S46.

That is, in the case of FIG. 11, the mixing rate detection unit 53 calculates the difference absolute values |C−L2|, |C−L1|, |C−R1|, and |C−R2| of the pixel values between the target pixel C and the respective horizontal processing direction component pixels L2, L1, R1, and R2 and obtains the maximum value of the calculated respective difference absolute values as the Mix rate Mr_{-H} which is the mixing rate to be output to the mixing unit 52.

That is, in a case where the minute edge does not exist, in accordance with the maximum value of the difference absolute values of the pixel values between the target pixel and the respective horizontal processing direction component pixels, the image signal subjected to the nonlinear filtering processing S_{LPF-H} is mixed with the luminance signal Y1 of the input image data, and the image signal SF−H subjected to the nonlinear smoothing processing is generated. In a case where the minute edge exists, the luminance signal Y1 of the input image data is output as it is.

As a result, in the nonlinear smoothing processing unit 32, the minute edge is detected by using the threshold ε₃ as the reference. The nonlinear smoothing processing is set not to be applied on the part where the minute edge exists, and also for the part where no edge exists, the pixel value subjected to the nonlinear smoothing processing in accordance with the magnitude of the difference absolute value is mixed with the input image signal. Thus, in particular, it is possible to prevent the situation in which a significant degradation in the image quality is caused in a simple pattern image composed of a minute edge or the like.

Herein, the description is back to the flow chart of FIG. 10.

In step S26, the Flat rate calculation unit 35 respectively calculates the difference absolute values of the pixel values between the target pixel and the respective vertical reference direction component pixels adjacent in the vertical direction with respect to the target pixel. That is, in the case of FIG. 11, the Flat rate calculation unit 35 calculates the difference absolute values |C−U2|, |C−U1|, |C−D1|, and |C−D2| of the pixel values between the target pixel C and the respective vertical reference direction component pixels U2, U1, D1, and D2 adjacent in the vertical direction.

In step S27, the Flat rate calculation unit 35 obtains a difference absolute value having the maximum value of the difference absolute values between the target pixel and the respective vertical reference direction component pixels adjacent in the vertical direction with reference to the target pixel and supplies this value as the Flat rate Fr_{-V} to the mixing unit 33.

In step S28, on the basis of the Flat rate Fr_{-V} supplied from the Flat rate calculation unit 35, the mixing unit 33 mixes the luminance signal Y1 of the input image data with the image signal S_{F-H} subjected to the nonlinear smoothing processing by the nonlinear smoothing processing unit 32 to be output as the image signal subjected to the horizontal smoothing processing SNL−H to the buffer 23. In more detail, the mixing unit 33 computes the following Expression (4) and mixes the luminance signal Y1 of the input image data with the image signal SF−H subjected to the nonlinear smoothing processing by the nonlinear smoothing processing unit 32.

S_{NL-H}=S_{F-H}×Fr_{-V}/Fr_{-H max}+Y1×(1−Fr_{-V}/Fr_{-V max}) (4)

Herein, Fr_{-V} denotes the Flat rate in the vertical direction, and Fr_{-V max} denotes the maximum value of the Flat rates Fr_{-V} in the vertical direction, that is, the difference absolute value between the maximum value and the minimum value in the dynamic range of the pixel values. The Flat rate Fr_{-V} is the maximum value of the difference absolute values between the vertical reference direction component pixels and the target pixel. Thus, as the value is smaller, in the area of the target pixel and the vertical reference direction component pixels adjacent in the vertical direction with reference to the target pixel, the change in the pixel value is smaller, and visually the change in the color is smaller. Thus, it can be mentioned that the flat state in appearance is established. On the other hand, when the Flat rate Fr_{-V} is large, in the area of the target pixel and the vertical reference direction component pixels adjacent in the vertical direction with reference to the target pixel, the change between the pixels is large. Thus, the non-flat state in appearance is established.

For this reason, as represented by Expression (4), as the Flat rate Fr_{-V} is larger, the weighting of the image signal S_{F-H} subjected to the nonlinear smoothing processing by the nonlinear smoothing processing unit 32 is increased, and the weighting of the unprocessed luminance signal Y1 of the input image data is decreased. On the other hand, as the Flat rate Fr_{-V} is smaller, that is, as the difference absolute value of the pixel values between the pixels in the vertical direction is smaller, the weighting of the image signal S_{F-H} subjected to the nonlinear smoothing processing by the nonlinear smoothing processing unit 32 is decreased, and the weighting of the unprocessed luminance signal Y1 of the input image data is increased.

In step S29, the horizontal processing direction component pixel extraction unit 31 determines whether or not all the pixels are processed as the target pixel, that is, the unprocessed pixel exists. For example, in a case where it is determined that all the pixels are not processed as the target pixel, that is, the unprocessed pixel exists, the processing is returned to step S21. Then, in step S28, in a case where it is determined that all the pixels processed as the target pixel, that is, the unprocessed pixel does not exist, the processing is ended, and the processing in step S11 of FIG. 9 is ended. It should be noted that the vertical reference direction component pixel extraction unit 34 also similarly determines whether or not all the pixels are processed as the target pixel, that is, the unprocessed pixel exists, and in either case, only in a case where it is determined that the unprocessed pixel does not exist, the process may be ended.

As a result, in accordance with the Flat rate in the vertical direction Fr_{-V} obtained by the difference absolute values of the pixel values between the vertical reference direction component pixels adjacent in the vertical direction with reference to the target pixel, the image signal S_{F-H} subjected to the nonlinear smoothing processing in the horizontal direction is mixed with the luminance signal Y1 of the input image data. In a case where the correlation in the vertical direction is strong, that is, the Flat rate in the vertical direction Fr_{-V} is small and the correlation in the vertical direction is strong, the weighting of the luminance signal Y1 of the input image data is increased, and in contrast, in a case where the Flat rate in the vertical direction Fr_{-V} is large and the correlation in the vertical direction weak, the weighting of the image signal subjected to the nonlinear filtering processing in the horizontal direction S_{F-H} is increased. Thus, while attention is paid on the edge, it is possible to suppress the unnatural processing in accordance with the processing direction (in accordance with whether the neighboring pixels used for the nonlinear smoothing processing are pixels adjacent in the horizontal direction with respect to the target pixel or the pixels adjacent in the vertical direction).

It should be noted that in the above, upon the mixing, the explanation has been given on the example in which the pixel value is multiplied by the Flat rate Fr_{-V} as it is as the weighting coefficient, but the image signal subjected to the nonlinear filtering processing S_{F-H} and the luminance signal Y1 of the input image data may be respectively multiplied by a weighting coefficient in accordance with other Flat rate to be mixed. That is, for example, as shown in FIG. 18, by using the weighting coefficients W₁ and W₂ set in accordance with the Flat rate Fr_{-V}, the following Expression (5) may be used to perform the mixing.

S_{NL-H}=Y1×W₁+S_{F-H}×W₂ (5)

Herein, W₂ denotes a weighting coefficient of the image signal subjected to the nonlinear filtering processing in the horizontal direction S_{F-H}, and W₁ denotes a weighting coefficient of the luminance signal Y1 of the input image data. Also, (W₁+W₂) denotes a maximum value Wₘₐₓ (=1) of the weighting coefficients.

That is, in FIG. 18, in a range where the Flat rate Fr_{-H} is smaller than Fr₁ (Fr_{-V}<Fr1), the weighting coefficient W₁ is the maximum value Wₘₐₓ of the weighting coefficients, and the weighting coefficient W₂ is 0. In a range where the Flat rate Fr−V is equal to or larger than Fr1 and also equal to or smaller than Fr2 (Fr1≦Fr_{-V}≦Fr2), the weighting coefficient W₁ is decreased in proportion to the Flat rate Fr_{-V}, and the weighting coefficient W2 is increased in proportion to the Flat rate Fr_{-V}, and also (W₁+W₂) is set to be the maximum value Wₘₐₓ (=1) of the weighting coefficients. Furthermore, in a range where the Flat rate Fr−V is larger than Fr2 (Fr2≦Fr−V), the weighting coefficient W₁ is 0, and the weighting coefficient W₂ is the maximum value Wₘₐₓ of the weighting coefficients.

As a result, while paying attention to the presence or absence of the edge precisely, it is possible to set the image to be nonlinearly smoothed. It should be noted that in the case of Fr1=Fr2, by using a state in which the Flat rate Fr_{-V} is Fr1 (=Fr2) as the threshold, the output image signal is output while either of the luminance signal Y1 of the input image data or the image signal S_{F-H} subjected to the nonlinear smoothing processing is switched.

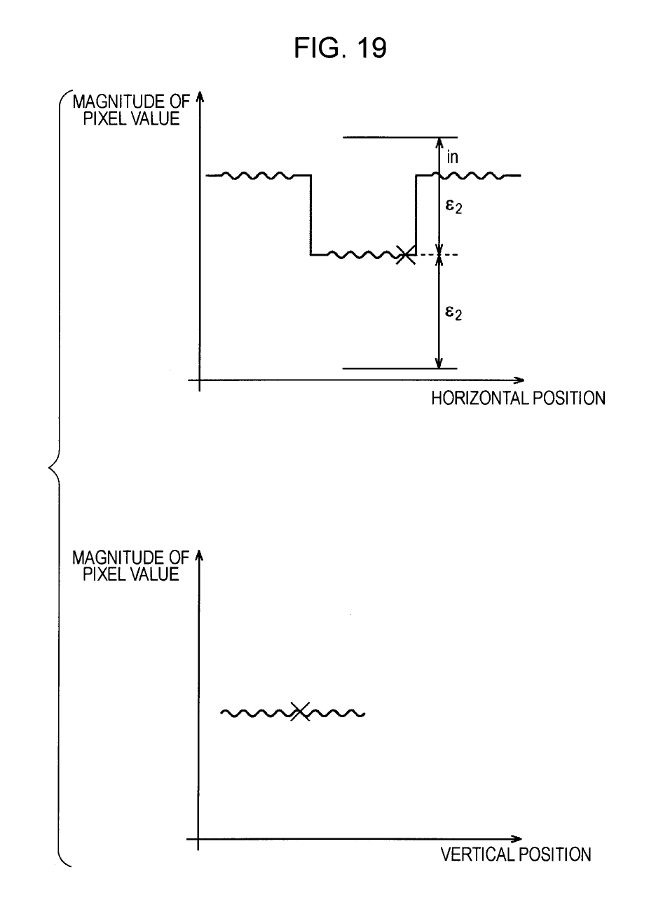

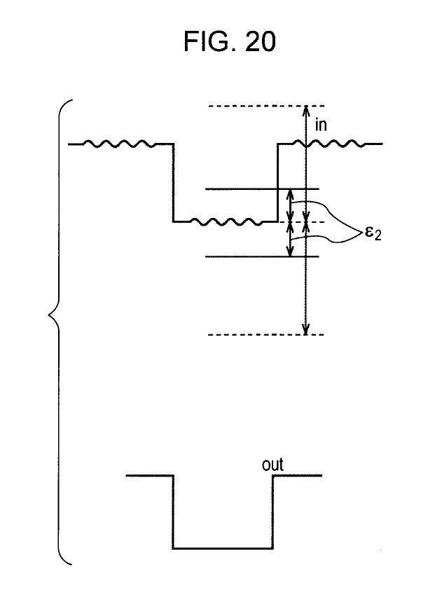

Also, through the above-mentioned threshold setting processing which is the processing in step S24 in the flow chart of FIG. 10, for example, in a case where a rectangular wave shown in the upper part of FIG. 19 exists and the target pixel is marked by the cross in the drawing, as shown in the lower part of FIG. 19, by setting the magnitude of the threshold ε₂ on the basis of the waveforms of the vertical reference direction pixels, it is possible to set the threshold as shown in the upper part of FIG. 20. Therefore, as shown in the upper part of FIG. 19, the problem that the waveform is changed into a waveform shown in the middle stage of FIG. 1 as the change of the pixel value of the rectangular wave is large can be solved, and as shown in the lower part of FIG. 20, while maintaining the rectangular wave, it is possible to smooth the amplitude component alone.

Herein, the explanation is back to the flow chart of FIG. 9.

As in the above-mentioned manner, in step S11, the horizontal direction smoothing processing unit 22 sequentially stores the image signals S_{NL-H} generated through the horizontal direction smoothing processing in the buffer 23.

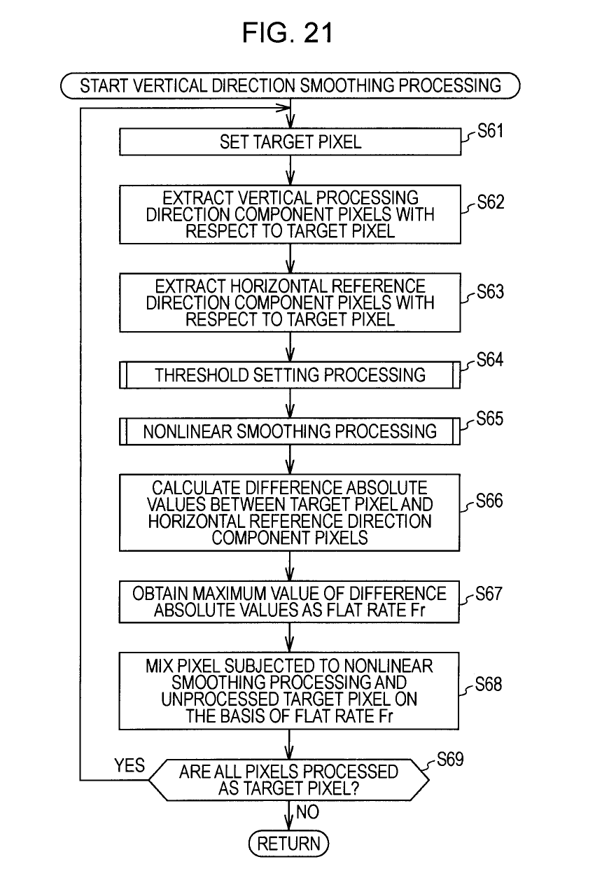

In step S12, the vertical direction smoothing processing unit 24 uses the image signals S_{NL-H} subjected to the horizontal direction smoothing processing which are sequentially stored in the buffer 23 to execute the vertical direction smoothing processing. Herein, with reference to a flow chart of FIG. 21, the vertical direction smoothing processing will be described. It should be noted that the vertical direction smoothing processing is a processing in which the horizontal direction processing of the processing in the horizontal direction smoothing processing is replaced by the vertical direction processing, and the processing contents are similar to each other. Also, the threshold setting processing is a similar processing except that instead of the pixels adjacent in the vertical direction with respect to the target pixel, the pixels adjacent in the horizontal direction and the target pixel are used, a description thereof will be omitted.

That is, in step S61, the vertical processing direction component pixel extraction unit 41 of the vertical direction smoothing processing unit 24 sets the target pixel in the raster scan order. At the same time, the horizontal reference direction component pixel extraction unit 44 also similarly sets the target pixel in the raster scan order. It should be noted that the setting order of the target pixel may be in an order other than the raster scan, but the target pixel set by the vertical processing direction component pixel extraction unit 41 and the target pixel set by the horizontal reference direction component pixel extraction unit 44 should be set identical to each other.

In step S62, the vertical processing direction component pixel extraction unit 41 extracts the pixel values of the total five pixels including the target pixel and also the vertical reference direction component pixels which are the two neighboring pixels each adjacent in the vertical direction (up and down direction) with respect to the target pixel from the buffer 23 to be output to the nonlinear smoothing processing unit 42. For example, in the case shown in FIG. 11, the pixels U2, U1, C, D1, and D2 are extracted as the target pixel and the vertical reference direction component pixels.

In step S63, the horizontal reference direction component pixel extraction unit 44 extracts the total five pixel values including the target pixel and also the vertical reference direction component pixels which are the two neighboring pixels each in the horizontal direction (left and right direction) with respect to the target pixel from the buffer 23 to be output to the Flat rate calculation unit 45. For example, in the case shown in FIG. 11, the pixels L2, L1, C, R1, and R2 are extracted as the target pixel and the vertical reference direction component pixels.

In step S64, the threshold setting unit 46 executes the threshold setting processing.

In step S65, on the basis of the target pixel and the vertical processing direction component pixels supplied from the vertical processing direction component pixel extraction unit 41, the nonlinear smoothing processing unit 42 applies the nonlinear smoothing processing on the target pixel. It should be noted that the nonlinear smoothing processing in step S65 is similar to the nonlinear smoothing processing in step S25 of FIG. 10 except that the relation between the horizontal direction and the vertical direction is switched. Other processings are similar to each other, and a description thereof will be omitted. Therefore, through this processing, the nonlinear smoothing processing unit 42 outputs the image signal S_{F-V} subjected to the nonlinear smoothing processing in the vertical direction to the mixing unit 43.

In step S66, the Flat rate calculation unit 45 respectively calculates the difference absolute values of the pixel values between the target pixel and the respective horizontal reference direction component pixels adjacent in the horizontal direction with respect to the target pixel. That is, in the case of FIG. 9, the Flat rate calculation unit 45 calculates the difference absolute values |C−L2|, |C−L1|, |C−R1|, and |C−R2| of the pixel values between the target pixel C and the respective horizontal reference direction component pixels L2, L1, R1, and R2 adjacent in the horizontal direction.

In step S67, the Flat rate calculation unit 45 obtains a difference absolute value having the maximum value of the difference absolute values between the target pixel and the respective horizontal reference direction component pixels adjacent in the horizontal direction with respect to the target pixel and supplies this value as the Flat rate Fr_{-H} to the mixing unit 43.

In step S68, on the basis of the Flat rate Fr_{-H} supplied from the Flat rate calculation unit 45, the mixing unit 43 mixes the input image signal S_{NL-H} the nonlinear smoothing processing in the horizontal direction by the horizontal direction smoothing processing unit 22 with the image signal SF−V subjected to the nonlinear smoothing processing by the nonlinear smoothing processing unit 42 and uses the neighboring pixels in the vertical direction to output the edge component ST1 which is the image signal subjected to the smoothing processing to the buffer 25. In more detail, the mixing unit 43 computes the following Expression (6) and mixes the input image signal S_{NL-H} subjected to the nonlinear smoothing processing in the horizontal direction with the image signal S_{F-V} the nonlinear smoothing processing by the nonlinear smoothing processing unit 42 in the vertical direction.

ST1=S_{F-V}×Fr_{-H}/Fr_{-H max}+S_{NL-H}×(1−Fr_{-H}/Fr_{-H max}) (6)

Herein, Fr_{-H} denotes the Flat rate in the horizontal direction, and Fr_{-H max} denotes the maximum value of the Flat rates Fr_{-H}, that is, the difference absolute value between the maximum value and the minimum value in the dynamic range of the pixel values. The Flat rate Fr_{-H} is the maximum value of the difference absolute values between the respective horizontal reference direction component pixels adjacent in the horizontal direction and the target pixel. Therefore, as the value is smaller, in the area of the target pixel and the neighboring pixels adjacent to the target pixel in the horizontal direction, the change in the pixel value is smaller, and visually the change in the color is smaller. Thus, it can be mentioned that the flat state in appearance is established. On the other hand, when the Flat rate Fr_{-H} is large, in the area of the target pixel and the vertical reference direction component pixels adjacent to the target pixel in the vertical direction, the change between the pixels is large. Thus, the non-flat state in appearance is established.

For this reason, as represented by Expression (6), as the Flat rate Fr_{-H} is larger, the weight of the image signal S_{F-V} subjected to the nonlinear smoothing processing in the vertical direction by the nonlinear smoothing processing unit 42 is increased, and the weight of the image signal S_{NL-H} subjected to the horizontal direction smoothing processing is decreased. On the other hand, as the Flat rate Fr_{-H} is smaller, that is, as the difference absolute values of the pixel values between the pixels in the horizontal direction is smaller, the weight of the image signal S_{F-V} subjected to the nonlinear smoothing processing in the vertical direction by the nonlinear smoothing processing unit 32 is decreased, and the weight of the input image signal S_{NL-H} subjected to the nonlinear smoothing processing in the horizontal direction is increased.

In step S69, the vertical processing direction component pixel extraction unit 41 determines whether or not all the pixels are processed as the target pixel, that is, the unprocessed pixel exists. For example, in a case where it is determined that all the pixels are not processed as the target pixel, that is, the unprocessed pixel exists, the processing is returned to step S61. Then, in step S69, in a case where it is determined that all the pixels are processed as the target pixel, that is, the unprocessed pixel does not exist, the processing is ended, and the processing in step S12 of FIG. 9 is ended. It should be noted that the horizontal reference direction component pixel extraction unit 44 also similarly determines whether or not all the pixels are processed as the target pixel, that is, the unprocessed pixel exists, and in either case, only in a case where it is determined that the unprocessed pixel does not exist, the process may be ended.

As a result, in accordance with the Flat rate Fr_{-H} obtained from the difference of the pixel values of the vertical reference direction component pixels adjacent in the horizontal direction with respect to the target pixel, the image signal subjected to the smoothing processing in the vertical direction S_{F-V} is mixed with the input image signal S_{NL-H}. In a case where the correlation in the horizontal direction is strong, that is, the Flat rate Fr_{-H} in the horizontal direction is small and the correlation in the horizontal direction is strong, the weighting of the input image signal subjected to the horizontal direction linear smoothing processing S_{NL-H} is increased, and in a case where the Flat rate Fr_{-H} in the horizontal direction is large and the correlation in the horizontal direction is weak, the weighting of the image signal subjected to the nonlinear filtering processing in the vertical direction S_{F-V} is increased. Thus, while attention is paid on the edge, it is possible to suppress the unnatural processing in accordance with the processing direction (in accordance with whether the neighboring pixels used for the nonlinear smoothing processing are pixels adjacent in the horizontal direction with respect to the target pixel or the pixels adjacent in the vertical direction).

It should be noted that in the above, upon the mixing, the explanation has been given on the example in which the pixel value is multiplied by the Flat rate Fr_{-H} as it is as the weighting coefficient, but, the image signal subjected to the smoothing processing S_{F-V} and the input image signal S_{NL-H} subjected to the horizontal direction smoothing processing may be respectively multiplied by a weighting coefficient in accordance with other Flat rate Fr−H to be mixed. That is, as shown in FIG. 18 in the above-mentioned horizontal direction smoothing processing, similarly to the case where the weighting coefficients W₁ and W₂ set in accordance with the Flat rate Fr_{-H} are used, the edge component ST1 which is the image signal subjected to the smoothing processing in the vertical direction may be obtained as represented by the following Expression (7).

ST1=S_{NL-H}×W₁₁+S_{F-V}×W₁₂ (7)

Herein, W₁₂ denotes a weighting coefficient of the image signal subjected to the smoothing processing in the vertical direction S_{F-V}, and W₁₁ denotes a weighting coefficient of the input image signal S_{NL-H} subjected to the horizontal direction smoothing processing. Also, (W₁₁+W₁₂) denotes a maximum value of the weighting coefficient.

As a result, while paying attention to the presence or absence of the edge precisely, it is possible to set the generated image to be nonlinearly smoothed.

Herein, the description is back to the flow chart of FIG. 9.

In step S12, when the vertical direction smoothing processing, in step S13, it is determined whether or not the next image is input. In a case where it is determined that the next image is input, the processing is returned to step S11, and the processing in step S11 and subsequent steps will be repeatedly performed. In step S13, it is determined whether or not the next image is not input, that is, the image signal is ended, and the processing is ended.

FIG. 22 shows a configuration example of the transient improvement unit 13 of the signal processing apparatus according to the embodiment of the present invention shown in FIG. 1.

The transient improvement unit 13 according to the example of FIG. 22 applies the transient improvement processing on the edge component ST1 and can output the improved edge component ST2 obtained as the result of the processing.

The transient improvement unit 13 of FIG. 22 is configured by including a delay unit 101, a delay unit 102, a MAX unit 103, a MIN unit 104, the computation unit (HPF) 105, and a switching unit 106.

The delay unit 101 delays the edge component ST1 supplied from the nonlinear filter unit 11, for example, by N pixels (N is an integer equal to or larger than 1) and supplies the edge component ST1 to the MAX unit 103, the MIN unit 104, and the computation unit (HPF) 105.

The delay unit 102 delays the edge component ST1 supplied from the delay unit 101, for example, by the N pixels (N is an integer equal to or larger than 1) and supplies the edge component ST1 to the MAX unit 103, the MIN unit 104, and the computation unit (HPF) 105.

Herein, the edge component ST1 output from the delay unit 101 is set as a signal corresponding to the target pixel (hereinafter, referred to as target pixel signal Np). Then, the edge component ST1 output from the delay unit 102 can be regarded as a signal corresponding to a pixel away from the target pixel, for example, by the N pixels in the horizontal right direction (hereinafter, abbreviated as right direction pixel signal). Also, the edge component ST1 supplied from the nonlinear filter unit 11 can be regarded as a signal corresponding to a pixel away from the target pixel, for example, by the N pixels in the horizontal left direction (hereinafter, abbreviated as left direction pixel signal).

In this case, the left direction pixel signal, the target pixel signal Np, and the right direction pixel signal are input to each of the MAX unit 103, the MIN unit 104, and the computation unit (HPF) 105.

The MAX unit 103 supplies a signal at the maximum level among the respective signal levels (pixel values) of the left direction pixel signal, the target pixel signal Np, and the right direction pixel signal (hereinafter, referred to as three-pixel maximum pixel signal Max) to the switching unit 106.

The MIN unit 104 supplies a signal at the minimum level among the respective signal levels (pixel values) of the left direction pixel signal, the target pixel signal, and the right direction pixel signal (hereinafter, referred to as three-pixel minimum pixel signal Min) to the switching unit 106.

The computation unit (HPF) 105 computes a quadratic differential value in the target pixel from the left direction pixel signal, the target pixel signal, and the right direction pixel signal and supplies a signal obtained as a result of the computation as a control signal Control to the switching unit 106.

To the switching unit 106, the target pixel signal Np, the three-pixel minimum pixel signal Min, and the three-pixel maximum pixel signal Max are input. The switching unit 106 decides an output signal among these three signals on the basis of the control signal from the computation unit (HPF) 105 and outputs the signal as the target pixel signal of the improved edge component ST2.

That is, the target pixel signal of the improved edge component ST2 is a signal selected and output by the switching unit 106 among the target pixel signal Np of the edge component ST1 itself, the three-pixel minimum pixel signal Min, and the three-pixel maximum pixel signal Max.

Herein, with reference to FIG. 23, an outline of an operation of the transient improvement unit 13 according to the example of FIG. 22 will be described.

FIG. 23 shows timing charts of the edge component ST1, the three-pixel maximum pixel signal Max, the target pixel signal Np, the three-pixel minimum pixel signal Min, the control signal Control, and the improved edge component ST2 supplied from the nonlinear filter unit 11 in the order from the above.

It should be noted that at respective times t1 to t6, the signal level of the target pixel signal Np indicates a pixel value of the target pixel of the edge component ST1 before the transient improvement.

Also, a signal level of the control signal Control takes, as shown in FIG. 23, one of three levels including a high level H, a middle level M, and a low level L.

In this case, when the control signal Control is at the high level H, the switching unit 106 outputs the three-pixel maximum pixel signal Max as the target pixel signal of the improved edge component ST2. The switching unit 106 outputs the target pixel signal Np as the target pixel signal of the improved edge component ST2 when the control signal Control is at the middle level M. The switching unit 106 outputs the three-pixel minimum pixel signal Min as the target pixel signal of the improved edge component ST2 when the control signal Control is at the low level L.

That is, from the time t1 to the time t2, as the control signal Control is at the low level L, as the target pixel signal of the improved edge component ST2, the three-pixel minimum pixel signal Min is output. From the time t2 to the time t3, as the control signal Control is at the high level H, as the target pixel signal of the improved edge component ST2, the three-pixel maximum pixel signal Max is output. From the time t3 to the time t4, as the control signal Control is at the middle level M, as the target pixel signal of the improved edge component ST2, the target pixel signal Np is output. From the time t4 to the time t5, as the control signal Control is at the high level H, as the target pixel signal of the improved edge component ST2, the three-pixel maximum pixel signal Max is output. From the time t5 to the time t6, as the control signal Control is at the low level L, as the target pixel signal of the improved edge component ST2, the three-pixel minimum pixel signal Min is output.

In this manner, the improved edge component ST2 in which the transient of the edge component ST1 is improved is output.

As described above, the signal processing apparatus according to the example of FIG. 1 can separate the luminance signal Y1 into the edge component ST1 and the component TX1 other than the edge. The signal processing apparatus according to the example of FIG. 1 can improve the transient of the edge component ST1 (for example, see the improved edge component ST2 of FIGS. 3 and 23) and also amplify the component TX1 other than the edge.

The present invention is not particularly limited to the embodiment of FIG. 1 and can adopt various embodiments.

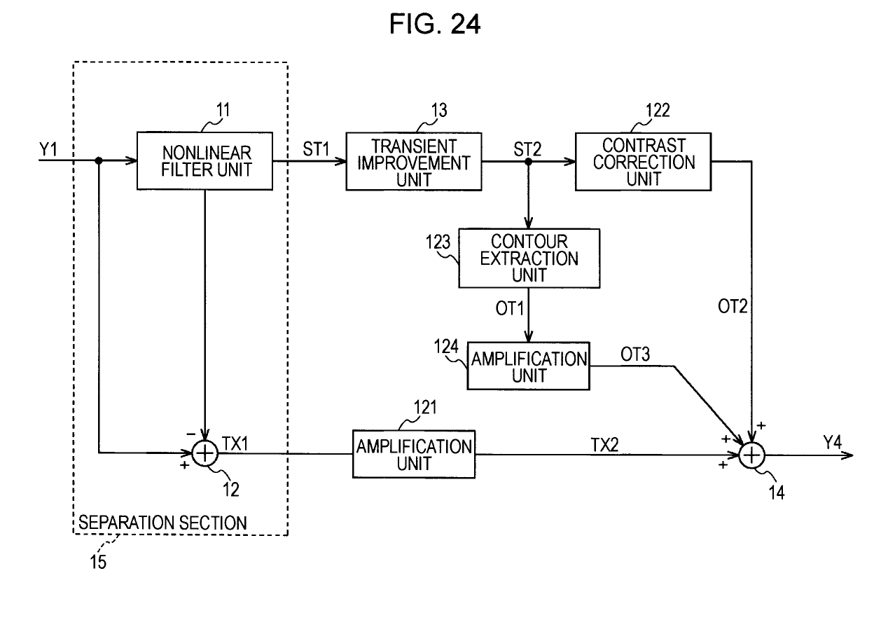

For example, FIG. 24 shows an embodiment different from the signal processing apparatus according to the embodiment of the present invention shown in FIG. 1. It should be noted that an information processing apparatus according to the example of FIG. 24 will be hereinafter referred to as contour emphasis image processing apparatus to be distinguished from the example of FIG. 1.

The contour emphasis image processing apparatus according to the example of FIG. 24 is composed by including the nonlinear filter unit 11, the subtractor unit 12, the transient improvement unit 13, an amplification unit 121, a contrast correction unit 122, a contour extraction unit 123, an amplification unit 124, and the adder unit 14.

The nonlinear filter unit 11 extracts the edge component ST1 from the luminance signal Y1 of the input image data and supplies the edge component ST1 to the subtractor unit 12 and the transient improvement unit 13. It should be noted that the detailed example of the nonlinear filter unit 11 is similar to that described with reference to FIGS. 4 to 21.

The subtractor unit 12 subtracts the edge component ST1 from the luminance signal Y1 of the input image data and supplies the resultant component TX1 other than the edge to the amplification unit 121.

The transient improvement unit 13 applies a predetermined transient improvement processing on the edge component ST1 supplied from the nonlinear filter unit 11 and supplies the improved edge component ST2 obtained as a result of the processing to the contrast correction unit 122 and the contour extraction unit 123. A detailed example of the transient improvement unit 13 is similar to that described with reference to FIGS. 22 and 23.

The amplification unit 121 amplifies the component TX1 other than the edge supplied from the subtractor unit 12 and a resultant amplified component TX2 other than the edge to the adder unit 14.

The contrast correction unit 122 applies a predetermined contract correction processing on the improved edge component ST2 supplied from the transient improvement unit 13 and supplies a resultant improved edge component OT2, that is, the improved edge component OT2 in which the contrast is corrected to the adder unit 14. It should be noted that hereinafter, the improved edge component OT2 in which the contrast is corrected will be referred to as contrast correction component OT2.

The contour extraction unit 123 applies a contour extraction processing on the improved edge component ST2 supplied from the transient improvement unit 13 and supplies a resultant contour extraction component OT1 to the amplification unit 124.

The amplification unit 124 amplifies the contour extraction component OT1 supplied from the contour extraction unit 123 and supplies an amplified contour extraction component OT3 to the adder unit 14.

The adder unit 14 adds the contrast correction component OT2 supplied from the contrast correction unit 122 and the component TX2 other than the edge supplied from the amplification unit 121 with the contour extraction component OT3 supplied from the amplification unit 124 and outputs a resultant luminance signal Y4.

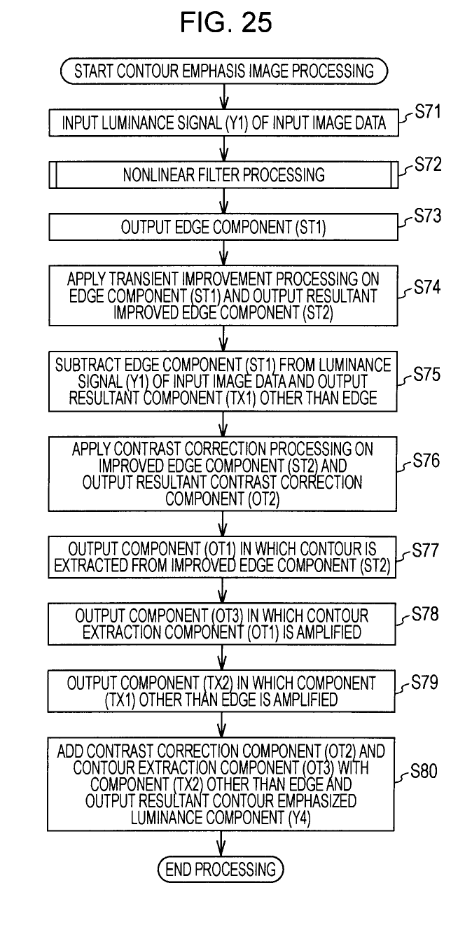

Next, with reference to a flow chart of FIG. 25, a contour emphasis image processing by the contour emphasis image processing apparatus of FIG. 24 will be described.

In step S71, the contour emphasis image processing apparatus inputs the luminance signal Y1 of the input image data. The input luminance signal Y1 is supplied to the nonlinear filter unit 11 and the subtractor unit 12.

In step S72, the nonlinear filter unit 11 applies the nonlinear filter processing on the luminance signal Y1 of the input image data. As a result, the edge component ST1 is obtained. It should be noted that the detailed example of the nonlinear filter processing is similar to that described by using FIGS. 9 to 21.

In step S73, the nonlinear filter unit 11 outputs the edge component ST1. The output edge component ST1 is supplied to the transient improvement unit 13 and the subtractor unit 12.

In step S74, the transient improvement unit 13 applies the transient improving processing on the edge component ST1 and outputs the improved edge component ST2 obtained as a result of the processing. The output improved edge component ST2 is supplied to the contrast correction unit 122 and the contour extraction unit 123. It should be noted that the detail example of the transient improvement processing is similar to that described by using FIG. 23.

In step S75, the subtractor unit 12 subtracts the edge component ST1 from the luminance signal Y1 of the input image data and outputs the resultant component TX1 other than the edge. The output component TX1 other than the edge is supplied to the amplification unit 121.

In step S76, the contrast correction unit 122 applies the contrast correction processing on the improved edge component ST2 and outputs the contrast correction component OT2 obtained as a result of the processing. The output contrast correction component OT2 is supplied to the adder unit 14.

In step S77, the contour extraction unit 123 applies the contour extraction processing on the improved edge component ST2 and outputs the contour extraction component OT1 obtained as a result of the processing. The output contour extraction component OT1 is supplied to the amplification unit 124.

In step S78, the amplification unit 124 applies the amplification processing on the contour extraction component OT1 supplied from the contour extraction unit 123 and outputs the contour extraction component OT3 obtained as a result of the processing, that is, the component OT3 in which the contour extraction component OT1 is amplified. The output contour extraction component OT3 is supplied to the adder unit 14.

In step S79, the amplification unit 121 applies the amplification processing on the component TX1 other than the edge supplied from the subtractor unit 12 and outputs the component TX2 other than the edge obtained as a result of the processing, that is, the component TX2 in which the component TX1 other than the edge is amplified. The output component TX2 other than the edge is supplied to the adder unit 14.

In step S80, the adder unit 14 adds the contrast correction component OT2 and the contour extraction component OT3 with the component TX2 other than the edge and outputs the luminance component Y4 obtained as a result of the adding in which the contour is emphasized.

As a result of the above-mentioned processing, the contour emphasis image processing apparatus including the signal processing apparatus according to the embodiment of the present invention applies the extraction of the contour component and the amplification with respect to the stable transient improvement component, so that the contour emphasis of an even higher frequency can be stably realized.

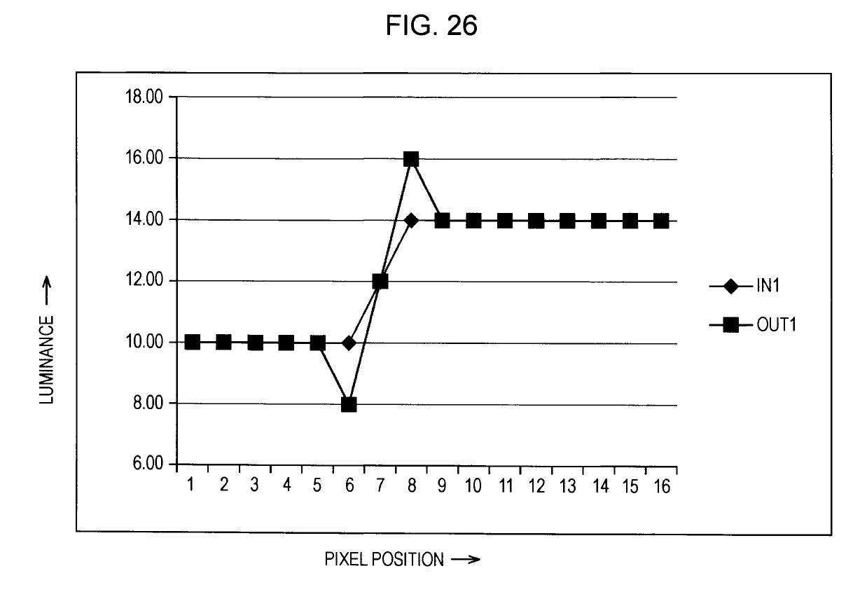

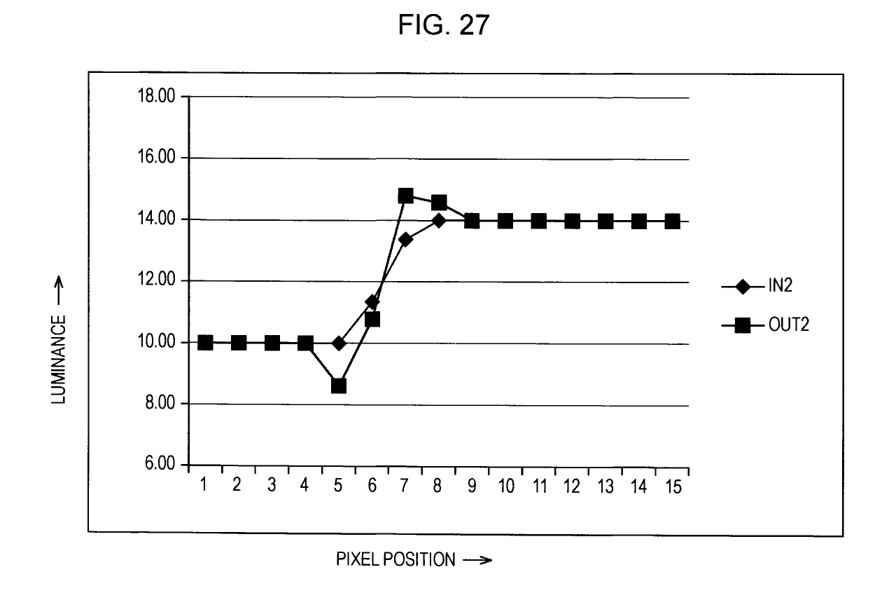

FIGS. 26 and 27 show examples of the contour emphasis with respect to the small amplitude edge through a technique in the related art.

According to the technique in the related art, it is difficult to perform the transient improvement with respect to the small amplitude edge. For this reason, in a case where the contour emphasis processing is applied with respect to a change of a minute sampling phase such as an input signal IN1 of FIG. 26 or an input signal IN2 of FIG. 27, there is a problem that as shown in an output signal OUT1 of FIG. 26 or an output signal OUT2 of FIG. 27, the contour emphasis levels are different from each other.

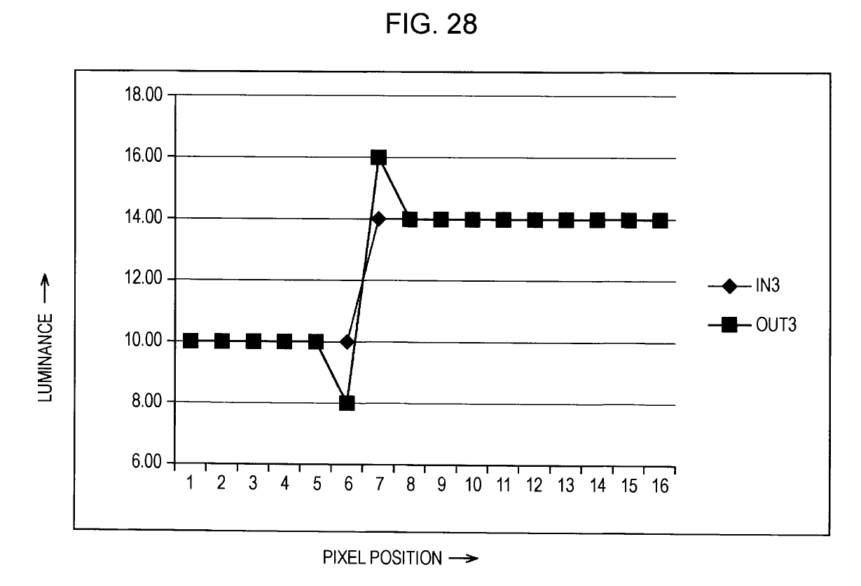

FIG. 28 shows an example of a contour emphasis processing result through a processing performed by the contour emphasis processing apparatus according to the example of FIG. 24.

An input signal IN3 is an example of the luminance signal of the improved edge component ST2 output in step S74 in the flow chart of FIG. 25.

An output signal OUT3 is an example of the luminance signal of the luminance component Y4 obtained as a result of the processing in step S75 and subsequent steps in the flow chart of FIG. 25 applied on the input signal IN3.

With the signal processing apparatus according to the embodiment of the present invention, the nonlinear filter unit 11 extracts the edge component alone from the luminance signal of the input image, and as the edge component does not include noise or the like, it is possible to apply the stable transient improvement processing on the edge component. For this reason, the stable transient improvement can be carried out on the edge having the edge component and the noise component or the edge having the small amplitude too, and the input signal IN3 shown in FIG. 28 can be obtained.

By applying the contour emphasis processing on the input signal IN3 whose transient is improved, it is possible to carry out the stable contour emphasis on the variation in the sampling phase or the noise too, and the output signal OUT3 can be obtained.

The above-mentioned series of processings including a list display processing can be executed by using hardware and also executed by using software.

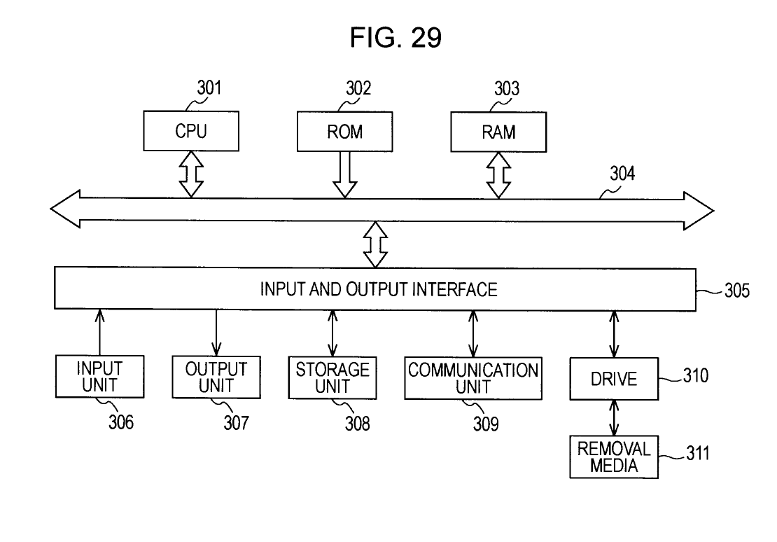

In a case where the above-mentioned series of processings is executed by using the software, the liquid crystal panel to which an embodiment of the present invention is applied can be composed, for example, by including a computer shown in FIG. 29. Alternatively, by the computer shown in FIG. 29, the drive for the liquid crystal panel to which the embodiment of the present invention is applied may be controlled.

In FIG. 29, a CPU (Central Processing Unit) 301 follows programs recorded on a ROM (Read Only Memory) 302 or programs loaded from a storage unit 308 to a RAM (Random Access Memory) 303 to execute various processings. Data and the like used for executing the various processings by the CPU 301 are also appropriately stored in the RAM 303.

The CPU 301, the ROM 302, and the RAM 303 are mutually connected via a bus 304. An input and output interface 305 is also connected to the bus 304.

An input unit 306 composed of a key board, a mouse, and the like, an output unit 307 composed of a display and the like, the storage unit 308 composed of the hard disk and the like, and a communication unit 309 composed of a modem, a terminal adapter, and the like are connected to the input and output interface 305. The communication unit 309 controls a communication carried out with another apparatus (not shown) via a network including the internet.

A drive 310 is connected to the input and output interface 305 as occasion demands. Removable recording media 311 composed of a magnetic disk, an optical disk, an opto-magnetic disk, a semiconductor memory, or the like are appropriately mounted, and computer programs read from these media are installed to the storage unit 308 as occasion demands

In a case where the series of processings are executed by using the software, a program constituting the software is installed from the network or the recording media, for example, to a computer incorporated in dedicated-use hardware or a general-use personal computer or the like which can execute various functions by installing various programs.

As shown in FIG. 29, the recording media including such programs is not only structured by the removable recording media (package media) 311 composed of a magnetic disk (including a flexible disk), an optical disk (including a CD-ROM (Compact Disk-Read Only Memory) and a DVD (Digital Versatile Disk)), an opto-magnetic disk (including an MD (Mini-Disk)), or a semiconductor memory or the like which records the programs and is distributed for providing the program to the viewer separately from the apparatus main body but also structured by the ROM 302, a hard disk included in the storage unit 308, or the like which records the programs and is provided to the viewer in a state of being previously incorporated in the apparatus main body.

It should be noted that in the present specification, steps for describing the programs recorded in the recording media of course includes a processing in which the steps are executed in a time series manner in the stated order and also includes a processing in which the steps are executed in a parallel manner or individually without being executed in the time series manner.

Also, in the present specification, the system represents an entire apparatus composed of a plurality of apparatuses and processing units.

The present application contains subject matter related to that disclosed in Japanese Priority Patent Application JP 2008-155209 filed in the Japan Patent Office on Jun. 13, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus comprising:
separation means configured to separate first image data into a first component in which an edge of the first image data is saved and a second component in which elements other than the edge are saved;
improvement means configured to apply a processing of improving a transient on the first component separated by the separation means; and
adder means configured to add the first component on which the processing by the improvement means is applied with the second component separated by the separation means and output second image data obtained as a result of the addition.

2. The signal processing apparatus according to claim 1, wherein the separation means includes:
filter means configured to apply a nonlinear filter in which the edge is saved on the first image data to extract and output the first component; and
subtractor means configured to subtract the first component output from the filter means, from the first image data and output the second component obtained as a result of the subtraction.

3. The signal processing apparatus according to claim 1, further comprising:
correction means configured to correct a contrast on the first component on which the processing by the improvement means is applied;
extraction means configured to apply a processing of extracting a contour from the first component on which the processing by the improvement means is applied to output a third component;
first amplification means configured to apply an amplification processing on the third component output by the extraction means; and
second amplification means configured to apply an amplification processing on the second component separated by the separation means,
wherein the first component on which the processing by the improvement means is applied and then on which the processing by the correction means is applied and the second component which is separated by the separation means and then on which the amplification processing by the second amplification means is applied are added with the third component on which the amplification processing by the first amplification means, and image data obtained as a result of the addition is output as second image data.

4. A signal processing method for a signal processing apparatus, the method comprising the steps of:
separating first image data into a first component in which an edge of the first image data is saved and a second component in which elements other than the edge are saved;
applying a processing of improving a transient on the first component separated from the first image data; and
adding the first component on which the processing is applied with the second component separated from the first image data and outputting second image data obtained as a result of the adding.

5. A program for causing a computer to execute a processing comprising the steps of:
separating first image data into a first component in which an edge of the first image data is saved and a second component in which elements other than the edge are saved;
applying a processing of improving a transient on the first component separated from the first image data; and
adding the first component on which the processing is applied with the second component separated from the first image data and outputting second image data obtained as a result of the adding.

6. A signal processing apparatus comprising:
a separation unit configured to separate first image data into a first component in which an edge of the first image data is saved and a second component in which elements other than the edge are saved;
an improvement unit configured to apply a processing of improving a transient on the first component separated by the separation unit; and
an adder unit configured to add the first component on which the processing by the improvement unit is applied with the second component separated by the separation unit and output second image data obtained as a result of the addition.
